(19) United States
(12) Patent Application Publication
(10) Pub. No.: US 2016/0148793 A1
(43) Pub. Date: May 26, 2016

(54) METHOD FOR OBTAINING MASS SPECTRUM OF IONS GENERATED AT CONSTANT TEMPERATURE BY MEASURING TOTAL ION COUNT, AND USE OF MATRIX FOR QUANTITATIVE ANALYSIS USING MALDI MASS SPECTROMETRY

(71) Applicant: ASTA CO., LTD., Suwon-si, Gyeonggi-do (KR)

(72) Inventors: Myung Soo KIM, Seoul (KR); Yong Jin BAE, Seoul (KR)

(21) Appl. No.: 14/759,160

(22) PCT Filed: Jan. 3, 2014
(86) PCT No.: PCT/KR2014/000048

§ 371 Date: Jul. 2, 2015

(30) Foreign Application Priority Data
Jan. 3, 2013 (KR) 10-2013-0000815
Jan. 3, 2013 (KR) 10-2013-0000817

(51) Int. Cl. H01J 49/00; H01J 49/16

(52) U.S. Cl. CPC H01J 49/0036; H01J 49/0009; H01J 49/164

(57) ABSTRACT

A method for obtaining a mass spectrum of reproducible ions generated at a constant temperature by measuring a total ion count, and the use of a matrix for quantitative analysis using MALDI mass spectrometry are disclosed. More particularly, a method for measuring a mass spectrum of ions generated at a constant temperature may include selecting only mass spectra having the same total ion count, among multiple mass spectra obtained from ions formed by applying energy to a specimen having a sample mixed therein.

### SEQUENCE LISTING

The instant application contains a Sequence Listing which has been submitted electronically in ASCII format and is hereby incorporated by reference in its entirety. Said ASCII copy, created on Sep. 21, 2015, is named 29929_CRF_and is 4,096 bytes in size.

### TECHNICAL FIELD

The present invention relates to a method for obtaining reproducible mass spectrum of ions generated at constant temperature by measuring total ion count and a use of a matrix for quantitative analysis using MALDI mass spectrometry. More particularly, the present invention relates to a method for obtaining mass spectrum of ions generated at constant temperature, the method including: selecting only the mass spectra having the same total ion count from among multiple mass spectra obtained from ions generated by applying energy to a sample having an analyte mixed therein. In addition, the present invention relates to a method for measuring the equilibrium constant of a proton exchange reaction between a matrix and an analyte at constant temperature, a method for obtaining a calibration curve for MALDI mass spectrometry, a method for quantitative analysis of an analyte using MALDI mass spectrometry, and a use of a matrix for quantitative analysis using MALDI mass spectrometry.

### BACKGROUND ART

Matrix-assisted laser desorption/ionization (MALDI) is a method allowing for ionization of various solid analytes. Usually, it is coupled with a time-of-flight (TOF) mass analyzer for use as MALDI-TOF. MALDI-TOF is widely used for structural analysis of various solid materials, particularly biomolecules, because of good sensitivity, wide range of application and short analysis time.

However, MALDI has the problem that the reproducibility of spectral patterns is very poor. Even when spectra are obtained by repetitively irradiating a laser to the same position of a sample, different spectral patterns are obtained. Due to the poor reproducibility of MALDI mass spectral patterns, the industrial or scientific applications of MALDI spectra are very limited. Therefore, many researchers are competing for the improvement of the reproducibility of MALDI mass spectral patterns.

For quantitative analysis of an analyte using MALDI mass spectrometry, various MALDI mass spectrometric techniques have been developed, including relative quantification without using an internal standard, relative quantification using an internal standard, absolute quantification using an internal standard, and absolute quantification using an analyte added.

The relative quantification without using an internal standard (or profile analysis) is a MALDI mass spectrometric method wherein a classification algorithm is used for reproducible analysis of MALDI mass spectra based on the fact that the relative signal intensity of each component in the MALDI mass spectra is constant. However, the weakness of the profile analysis method is that the design and practice of experiments are difficult.

The relative quantification using an internal standard is a MALDI mass spectrometric method wherein an analyte is quantified by measuring the peak height or area of each analyte in the MALDI mass spectra of samples to which a predetermined amount of an internal standard has been added relative to the peak height or area of the internal standard. However, with the relative quantification method using an internal standard, the absolute amount of the analyte cannot be determined.

The absolute quantification using an internal standard is a MALDI mass spectrometric method wherein a calibration curve is constructed from several samples containing different amount of an analyte to be measured as well as a constant amount of an internal standard, and the absolute amount of the analyte is determined from the calibration curve based on the relative amount of the analyte obtained from an unknown sample according to the relative quantification method using an internal standard described above. However, the absolute quantification method using an internal standard is disadvantageous in that a calibration curve has to be constructed for each component if a sample containing multiple components is to be analyzed.

The absolute quantification using an analyte added is a MALDI mass spectrometric method wherein a sample containing an analyte to be analyzed is divided into two or more samples, calibration points are obtained from the MALDI mass spectra obtained for the samples containing different amounts of the analyte, and the absolute amount of the analyte is determined from the calibration points. However, the absolute quantification method using an analyte added has the problem that the analyte to be analyzed needs to be prepared additionally and several samples are needed for the analysis of one analyte.

The currently known methods for quantitative analysis using MALDI mass spectra use an internal standard, particularly a compound identical to the analyte but substituted with an isotope. However, when the analyte has a large molecular weight, such as proteins, nucleic acids, etc., or when the degree of isotopic substitution is increased to distinguish the mass spectrum of the analyte substituted with the isotope from that of the unsubstituted analyte, the cost increases greatly. Another disadvantage of the MALDI mass spectrometry-based quantitative analysis using an internal standard is that the analyte pretreatment is not simple.

Since the sample in MALDI mass spectrometry is usually a mixture of an analyte and a matrix, an analyte ion (AH+) and fragmentation products thereof and a matrix ion (MH+) and fragmentation products thereof appear in the MALDI mass spectrum. Accordingly, the MALDI spectral pattern is determined by the fragmentation patterns of AH+ and MH+ and the ratio of the intensities of AH+ and MH+.

The ions generated by MALDI can be fragmented inside (in-source decay, ISD) or outside (post-source decay, PSD) the ion sources. The ISD occurs and terminates fast, whereas the PSD occurs slowly. The rate and yield of the fragmentation reaction of the analyte ion are determined by the reaction rate constant and the internal energy of the ion. Accordingly, if the effective temperature of a plume generated by a laser pulse in MALDI is known, the internal energy can be determined and the reaction rate can be calculated therefrom.

There have been many scientific researches to find out the temperature of a plume, which is a gas containing ions and neutral molecules generated when a laser is irradiated on a sample in MALDI mass spectrometry (J. Phys. Chem. 1994, 98, 1904-1909; J. Am. Soc. Mass Spectrom. 2007, 18, 607-616; J Phys. Chem. A 2004, 108, 2405-2410).

However, the most systematic method for measuring the plume temperature was first presented by the inventors of the present disclosure (J. Phys. Chem. B 2009, 113. 2071-2076). The inventors of the present disclosure have succeeded in obtaining the ion fragmentation reaction rate and effective temperature through kinetic analysis of time-resolved photodissociation spectra and PSD spectra. The obtained temperature was found to be the late plume temperature (Tₗₐₜₑ). The inventors of the present disclosure could also determine the early plume temperature (T_{early}) by analyzing the ISD yield using a reaction rate function obtained therefrom.

First, the inventors of the present disclosure measured the intensities of the fragmented ion products of peptide ions generated by ISD, PSD, etc. from MALDI spectra. From the data, the survival probabilities (Sin) of the peptide ions at the ion source exit were calculated. The maximum rate constant at which the peptide ions can survive at the ion source exit was obtained in consideration of the experimental conditions and the maximum internal energy corresponding thereto was determined from the fragmentation rate constant of the peptide ions. The internal energy distribution of the peptide ions was obtained while varying temperatures and T_{early}, i.e. the temperature at which the probability of the region below the maximum internal energy is identical to Sin, was determined.

The early and late temperatures of the ion-containing gas (plume) determined by the method devised by the inventors of the present disclosure matched well with those reported previously by other researchers. However, the method of the inventors of the present disclosure is advantageous in that it is methodologically more systematic and more universally applicable due to the lack of randomness, when compared with the methods devised by other researchers (Journal of the American Society for Mass Spectrometry, 2011, vol. 22, pp. 1070-1078).

Through researches, the inventors of the present disclosure have surprisingly found out that, although the early plume temperature (T_{early}) varies if the MALDI experimental condition is changed, the mass spectral patterns of the spectrums with the same T_{early} are identical even when the mass spectra are obtained under different experimental conditions.

That is to say, the inventors of the present disclosure have found out that the fragmentation pattern of a matrix is constant without regard to the analyte concentration if the early plume temperature in MALDI mass spectrometry is identical and, therefore, have completed this invention about a use of a matrix for quantitative analysis using MALDI mass spectrometry.

Based on the finding that quantitative analysis using MALDI mass spectrometry is possible by using a matrix, the inventors of the present disclosure have developed methods for quantitative analysis as follows.

Firstly, the inventors of the present disclosure have found out that the reaction quotient (Q=[M][AH+]/([MH+][A])) of a proton exchange reaction of a plume obtained from the spectra with the same T_{early} is constant without regard to the change in analyte concentration in solid samples. That is to say, the inventors of the present disclosure have found out that in MALDI-TOF mass spectrometry the early plume is almost in thermal equilibrium and the reaction quotient (Q) is equal to the equilibrium constant (K) of the proton exchange reaction between the matrix and the analyte. Accordingly, in MALDI-TOF mass spectra the ratio of the intensities of the analyte and matrix ions generated under a constant-temperature condition is proportional to the analyte-to-matrix molar ratio in the solid sample and quantitative analysis will be possible based thereon.

The inventors of the present disclosure have invented a method for measuring the equilibrium constant of an ionization reaction of a matrix and an analyte by measuring MALDI mass spectra several times while changing the MALDI experimental conditions, comparing the fragmentation patterns of the matrix ion included in the MALDI mass spectrometry sample, the analyte ion or the ion of the added material in each spectrum, selecting only the spectra wherein the ion fragmentation patterns of the materials are identical, and measuring the ratio of the matrix ion signal intensity and the analyte ion signal intensity from the selected MALDI spectra.

Secondly, the inventors of the present disclosure have invented a method for obtaining a calibration curve for the change in the ratio of the concentrations of a matrix and an analyte at constant temperature using the equilibrium constant of the reaction between the matrix and the analyte.

Thirdly, the inventors of the present disclosure have invented a method for quantitative analysis wherein the ratio of the analyte ion signal intensity and the matrix ion signal intensity measured from the MALDI mass spectra of a sample prepared by mixing an unknown amount of an analyte to a predetermined amount of a matrix and the concentration of the matrix are substituted into the calibration curve to measure the amount of the analyte included in the sample by calculating the moles of the analyte.

It is well known in the art to which the present disclosure belongs that, even when mass spectra are obtained for the same sample using the same MALDI mass spectrometer, different mass spectral patterns are obtained due to the difference in sample separation method, the location at which a laser reaches on the sample, the wavelength of the laser used, the pulse energy of the laser, the size of the spot at which the laser reaches, the number of laser irradiation on a given spot, or the like.

The poor reproducibility of the mass spectral patterns is a big obstacle to basic researches, precision analysis, standardization and, in particular, quantitative analysis. When considering that MALDI mass spectrometry is a technique which has very high sensitivity, is convenient to use and can be quickly applied to various analytes to be analyzed, improvement of the reproducibility of the MALDI spectral patterns will lead to extension of its applications.

Since the sample in MALDI mass spectrometry is usually a mixture of an analyte and a matrix, an analyte ion (AH⁺) and fragmentation products thereof and a matrix ion (MH⁺) and fragmentation products thereof appear in the MALDI mass spectrum. Accordingly, the MALDI spectral pattern is determined by the fragmentation patterns of AH⁺ and MH⁺ and the ratio of the intensities of AH⁺ and MH⁺.

The ions generated by MALDI can be fragmented inside (in-source decay, ISD) or outside (post-source decay, PSD) the ion sources. The ISD occurs and terminates fast, whereas the PSD occurs slowly. The rate and yield of the fragmentation reaction of the analyte ion are determined by the reaction rate constant and the internal energy of the ion. Accordingly, if the temperature of a plume generated by a laser pulse in MALDI is known, the internal energy can be determined and the rate of the fragmentation reaction can be calculated therefrom.

There have been many scientific researches to find out the temperature of a plume, which is a gas containing ions generated when a laser is irradiated on a sample in MALDI mass spectrometry. Mowry et al. estimated the plume temperature by photoionizing neutral molecules desorbed by a laser (J. Phys. Chem. 1994, 98, 1904-1909), Yergey et al. estimated the temperature from the yield of in-source decay (ISD) (J. Am. Soc. Mass Spectrom. 2007, 18, 607-616), and Zenobi et al. estimated the plume temperature by measuring the light emitted by an analyte which had been excited by a laser pulse (J Phys. Chem. A 2004, 108, 2405-2410).

However, the most systematic method for measuring the plume temperature was first presented by the inventors of the present disclosure (J. Phys. Chem. B 2009, 113. 2071-2076). The inventors of the present disclosure have succeeded in obtaining the ion fragmentation reaction rate and effective temperature through kinetic analysis of time-resolved photodissociation spectra and PSD spectra. The obtained temperature was found to be the late plume temperature (Tₗₐₜₑ). The inventors of the present disclosure could also determine the early plume temperature (T_{early}) by analyzing the ISD yield using a reaction rate function obtained therefrom.

First, the inventors of the present disclosure measured the intensities of the fragmented ion products of analyte ions generated by ISD, PSD, etc. from MALDI spectra. From the measurement data, the survival probabilities (Sin) of the peptide ions at the ion source exit were calculated. The maximum rate constant at which the peptide ions can survive at the ion source exit was obtained in consideration of the experimental conditions and the maximum internal energy corresponding thereto was determined from the fragmentation rate constant of the peptide ions. The internal energy distribution of the peptide ions was obtained while varying temperatures and T_{early}, i.e. the temperature at which the probability of the region below the maximum internal energy is identical to Sin, was determined.

The early and late temperatures of the ion-containing gas (plume) determined by the method invented by the inventors of the present disclosure matched well with those reported previously by other researchers. However, the method of the inventors of the present disclosure is advantageous in that it is methodologically more systematic and more universally applicable due to the lack of randomness, when compared with the methods devised by other researchers (Journal of the American Society for Mass Spectrometry, 2011, vol. 22, pp. 1070-1078).

Through researches on the photodissociation reaction of analyte ions, the inventors of the present disclosure have determined the rate constant of the fragmentation reaction of the ions and have presented a method for determining the early temperature (T_{early}) of the gas (plume) containing the ions generated by MALDI (Yong Jin Bae, Jeong Hee Moon, and Myung Soo Kim, Expansion Cooling in the Matrix Plume is Under-Recognized in MALDI Mass Spectrometry, Journal of the American Society for Mass Spectrometry, vol. 22, pp. 1070-1078, 2011). Also, the inventors of the present disclosure have obtained MALDI mass spectra under different conditions and have measured the temperature when the ions are generated (T_{early}) from the MALDI mass spectra using the Kim et al.'s method.

Through these researches, the inventors of the present disclosure have surprisingly found out that, although the temperature when the ions are generated (T_{early}) varies if the MALDI experimental condition under which the ions are generated is changed, the mass spectra with the same T_{early} exhibit the same total ion count (TIC) even when the mass spectra are obtained under different experimental conditions.

In particular, having noticed that the major cause of the reproducibility problem of the MALDI spectral patterns is the temperature change in the ion generation reaction through MALDI researches on various analytes, the inventors of the present disclosure selected only the mass spectra having the same total ion count (TIC) from among multiple mass spectra obtained from a sample containing a matrix and analyte under various ionization reaction conditions and, thereby, could improve the reproducibility of the MALDI mass spectra.

The inventors of the present disclosure have invented a method for reproducibly measuring mass spectra of a substance ionized at constant temperature, by measuring MALDI mass spectra while changing MALDI ionization reaction conditions and selecting only the mass spectra having the same TIC.

In addition, for the commonly used MALDI-TOF mass spectrometer, it is necessary to deflect the matrix-derived ions to avoid detector saturation. To solve this problem, the inventors of the present disclosure have invented a dual track MALDI-TOF mass spectrometric technique.

### DISCLOSURE

### Technical Problem

It is a first object of the present disclosure to provide a method for measuring mass spectra of ions generated at constant temperature, including selecting only the mass spectra having the same total ion count from among multiple mass spectra obtained from ions generated by applying energy to a sample having an analyte mixed therein.

It is a second object of the present disclosure to provide a method for measuring the equilibrium constant of a proton exchange reaction between a matrix and an analyte at constant temperature, including: (i) selecting only the mass spectra having the same total ion count from among multiple mass spectra obtained from ions generated by applying energy to a sample having an analyte mixed therein; and (ii) measuring the value obtained by dividing the signal intensity of the analyte ion by the signal intensity of the matrix ion (ion signal ratio) from the MALDI mass spectra obtained in the step (i), wherein the ion signal ratio is divided by the concentration of the analyte divided by the concentration of the matrix (concentration ratio) to measure the equilibrium constant.

It is a third object of the present disclosure to provide a method for obtaining a calibration curve for MALDI mass spectrometry, including: (i) selecting only the mass spectra having the same total ion count from among multiple mass spectra obtained from ions generated by applying energy to a sample having an analyte mixed therein; (ii) measuring the value obtained by dividing the signal intensity of the analyte ion by the signal intensity of the matrix ion (ion signal ratio) from the MALDI mass spectra obtained in the step (i); and (iii) obtaining a calibration curve for MALDI mass spectrometry by plotting the ion signal ratio against the concentration of the analyte divided by the concentration of the matrix (concentration ratio).

It is a fourth object of the present disclosure to provide a method for quantitative analysis of an analyte using MALDI mass spectrometry, including: (i) selecting only the mass spectra having the same total ion count from among multiple mass spectra obtained from ions generated by applying energy to a sample having an analyte mixed therein; (ii) measuring the value obtained by dividing the signal intensity of the analyte ion by the signal intensity of the matrix ion (ion signal ratio) from the MALDI mass spectra obtained in the step (i); and (iii) calculating the molar concentration of the analyte by substituting the molar concentration of the matrix and the ion signal ratio obtained in the step (ii) into a calibration curve for MALDI mass spectrometry.

In addition, the inventors of the present disclosure have found out that the reaction quotient of the proton exchange reaction of the plume (Q=[M][AH⁺]/([MH⁺][A])) obtained from the spectra having the same T_{early} is constant for regardless of the change in analyte concentration in the solid samples. That is to say, the inventors of the present disclosure have found out that in MALDI-TOF mass spectrometry the early plume is almost in thermal equilibrium and the reaction quotient (Q) is equal to the equilibrium constant (K) of the proton exchange reaction between the matrix and the analyte. Accordingly, in MALDI-TOF mass spectra the ratio of the intensities of the analyte and matrix ions generated under a constant-temperature condition is directly proportional to the analyte-to-matrix molar ratio in the solid sample and quantitative analysis will be possible based thereon.

The inventors of the present disclosure have invented a method for measuring the equilibrium constant of an ionization reaction of a matrix and an analyte, by obtaining the mass spectra having the same T_{early} by selecting only the mass spectra having the same total ion count and then measuring the ratio of the signal intensity of the matrix ion and the signal intensity of the analyte ion signal intensity from the obtained mass spectra.

In addition, the inventors of the present disclosure have invented a method for obtaining a calibration curve for the change in the ratio of the concentrations of a matrix and an analyte at constant temperature using the equilibrium constant of the reaction between the matrix and the analyte.

Also, the inventors of the present disclosure have invented a method for quantitative analysis of measuring the amount of an analyte included in a sample prepared by mixing a predetermined amount of a matrix with an unknown amount of the analyte by calculating the moles of the analyte by substituting the ratio of the signal intensity of the analyte ion and the signal intensity of the matrix ion measured from the mass spectra of the sample as well as the concentration of the matrix into the calibration curve.

It is another object of the present disclosure to provide a novel use of a matrix material, i.e., a use of a matrix material for quantitative analysis of an analyte using MALDI mass spectrometry.

It is another object of the present disclosure to provide a method for quantitative analysis including a step obtaining multiple MALDI mass spectra from ions generated by applying energy to a sample having an analyte mixed therein.

It is another object of the present disclosure to provide a method for quantitative analysis using a dual track MALDI-TOF mass spectrometer.

### Technical Solution

The first object of the present disclosure described above can be achieved by providing a method for measuring mass spectra of ions generated at constant temperature, including selecting only the mass spectra having the same total ion count from among multiple mass spectra obtained from ions generated by applying energy to a sample having an analyte mixed therein.

In the present disclosure, the term “matrix” refers to a material which absorbs energy from an energy source such as a laser and transfers the energy to an analyte, thereby heating and ionizing the analyte. The matrix used in MALDI mass spectrometry may be selected from CHCA (α-cyano-4-hydroxycinnamic acid), DHB (2,5-dihydroxybenzoic acid), sinapinic acid, 4-hydroxy-3-methoxycinnamic acid, picolinic acid, 3-hydroxypicolinic acid, 2,6-dihydroxyacetophenone, 1,5-diaminonapthalene, 2,4,6-trihydroxyacetophenone, 2-(4′-hydroxybenzeneazo)benzoic acid, 2-mercaptobenzothiazole, chlorocyanocinnamic acid, fluorocyanocinnamic acid, etc.

In typical MALDI mass spectrometry, a laser pulse is irradiated to a solid sample consisting of a matrix (M) and a trace amount of an analyte (A). The matrix helps the absorption of the laser and, thus, the heating and ionization of the analyte. The resulting MALDI mass spectrum is a spectrum of a fragmented mixture of a matrix ion and an analyte ion.

The method for measuring mass spectra of ions generated at constant temperature of the present disclosure is applicable to quantitative analysis of not only macromolecules such as proteins, nucleic acids, peptides, metabolites, drugs, vitamins, sugars, toxic substances, harmful materials, etc. but also small molecules.

In the present disclosure, the term “total ion count (TIC)” refers to the total number of particles detected by a detector inside a mass spectrometer. Since part of the ions generated inside the mass spectrometer by MALDI are lost due to fragmentation, it is not easy to measure the total number of the ions generated by MALDI. Therefore, the total number of particles detected by a detector is defined as the total ion count as a measure of the total number of the ions generated by MALDI.

In the present disclosure, the term “plume” refers to a vapor generated from a sample by the energy of a laser pulse irradiated to the sample. The plume contains gaseous matrix molecules, analyte molecules, matrix ions and analyte ions. Among them, the gaseous matrix molecules constitute the most part of the plume.

In the present disclosure, the term “reaction quotient” is defined as Q=([C]^{c}[D]^{d})/([A]^{a}[B]^{b}) for a reaction aA+bB→cC+dD. When the chemical reaction is at equilibrium, the reaction quotient is equal to the equilibrium constant.

In the present disclosure, the term “calibration curve” or “calibration equation” refers to an empirically obtained curve about the relationship between the concentration of a component and the particular property of the component (e.g., electrical property, color development, etc.). The calibration curve is used for quantitative analysis of a component with an unknown concentration.

In the present disclosure, the term “ion signal ratio” is defined as the value obtained by dividing the signal intensity of an analyte ion (I_{AH+}) by the signal intensity of a matrix ion (I_{MH+}). And, in the present disclosure, the term “concentration ratio” is defined as the value obtained by dividing the moles of an analyte contained in a sample by the moles of a matrix contained in the sample ([A]/[M]).

In general, the ions appearing on a MALDI mass spectrum are protonated analyte (AH⁺), protonated matrix (MH⁺) and fragmented products thereof generated in an ion source. Accordingly, the pattern of a MALDI mass spectrum is determined by fragmentation pattern of AH⁺ and MH⁺ and the analyte-to-matrix ion ratio.

The inventors of the present disclosure have found out that the three factors are determined if T_{early} is specified in the early stage of MALDI (Bae, Y. J.; Moon, J. H.; Kim, M. S. J. Am. Soc. Mass Spectrom. 2011, 22, 1070-1078; Yoon, S. H.; Moon, J. H.; Kim, M. S. J. Am. Soc. Mass Spectrom. 2010, 21, 1876-1883). More specifically, they have found out that the proton exchange reaction between the matrix and the analyte, MH⁺+A→M+AH⁺, is almost in thermal equilibrium.

In addition, they have found out that, although the temperature when the ions are generated (T_{early}) varies if the MALDI experimental condition under which the ions are generated is changed, the mass spectra with the same T_{early} exhibit the same total ion count (TIC) even when the mass spectra are obtained under different experimental conditions. This phenomenon occurs also in the case where the sample contains the matrix and a third material in addition to the analyte.

That is to say, the signals of the analyte ion, the matrix ion and the fragmentation products thereof appear in the MALDI spectra and the MALDI spectra exhibiting reproducibility with the same relative and absolute intensities of the ions regardless of the experimental conditions can be obtained by selecting only the MALDI spectra having a specific T_{early}. It was also found out that, if the T_{early} is the same, the total number of the generated ions is constant regardless of the identity, concentration and quantity of the analyte included in the sample.

Therefore, the inventors of the present disclosure could improve the reproducibility of MALDI mass spectra by selecting only the mass spectra having the same total ion count (TIC) from among multiple mass spectra measured under different MALDI ionization reaction conditions.

In the method for measuring mass spectra of ions generated at constant temperature of the present disclosure, a means of applying energy to the sample may be a laser, a particle beam or other forms of radiation. The laser may be a nitrogen laser or a Nd:YAG laser.

The laser may be irradiated to one spot of the sample multiple times or may be irradiated to multiple spots of the sample to obtain multiple spectra of the analyte ion.

The second object of the present disclosure can be achieved by providing a method for measuring the equilibrium constant of a proton exchange reaction between a matrix and an analyte at constant temperature, including: (i) selecting only the mass spectra having the same total ion count from among multiple mass spectra obtained from ions generated by applying energy to a sample having an analyte mixed therein; and (ii) measuring the value obtained by dividing the signal intensity of the analyte ion by the signal intensity of the matrix ion (ion signal ratio) from the MALDI mass spectra obtained in the step (i), wherein the ion signal ratio is divided by the concentration of the analyte divided by the concentration of the matrix (concentration ratio) to measure the equilibrium constant.

In the method for measuring the equilibrium constant of a proton exchange reaction between a matrix and an analyte at constant temperature of the present disclosure, a means of applying energy to the sample may be a laser, a particle beam or other forms of radiation. The laser may be a nitrogen laser or a Nd:YAG laser.

The laser may be irradiated to one spot of the sample multiple times or may be irradiated to multiple spots of the sample to obtain multiple spectra of the analyte ion.

In a MALDI plume, a proton exchange reaction occurs between the matrix and the analyte as described in Reaction Formula (1):

MH⁺+A→M+AH⁺ (1)

The reaction quotient of Reaction Formula (1) is defined by Equation (2).

Q=[M][AH⁺]/([MH⁺][A])=([M]/[A])/([MH⁺]/[AH⁺]) (2)

In Equation (2), [M]/[A] can be obtained directly from the concentrations of the matrix and the analyte used for preparation of the sample.

And, in Equation (2), [AH⁺]/[MH⁺] is the value obtained by dividing the concentration of the ions derived from the analyte by the concentration of the ions derived from the matrix and is equal to the value obtained by dividing the signal intensity of the analyte-derived ions by the signal intensity of the matrix-derived ions (ion signal ratio), i.e. IAH+/IMH+, obtained in the step (ii) of the method for measuring the reaction quotient of a proton exchange reaction of the present disclosure. Then, Equation (2) can be written as follows.

Q=([M]/[A])/(IAH⁺/IMH⁺) (3)

Since both the [M]/[A] value and the IAH⁺/IMH⁺ value in Equation (3) can be obtained, the reaction quotient of a proton exchange reaction between the matrix and the analyte can be obtained. And, since this reaction is in equilibrium, the reaction quotient is equal to the equilibrium constant.

The third object of the present disclosure can be achieved by providing a method for obtaining a calibration curve for MALDI mass spectrometry, including: (i) selecting only the mass spectra having the same total ion count from among multiple mass spectra obtained from ions generated by applying energy to a sample having an analyte mixed therein; (ii) measuring the value obtained by dividing the signal intensity of the analyte ion by the signal intensity of the matrix ion (ion signal ratio) from the MALDI mass spectra obtained in the step (i); and (iii) obtaining a calibration curve for MALDI mass spectrometry by plotting the ion signal ratio against the concentration of the analyte divided by the concentration of the matrix (concentration ratio).

In the method for obtaining a calibration curve for MALDI mass spectrometry of the present disclosure, a means of applying energy to the sample may be a laser, a particle beam or other forms of radiation. The laser may be a nitrogen laser or a Nd:YAG laser. Specifically, the laser may be irradiated to one spot of the sample multiple times or may be irradiated to multiple spots of the sample to obtain multiple spectra of the analyte ion.

Also, in the method for obtaining a calibration curve for MALDI mass spectrometry of the present disclosure, the calibration curve for MALDI mass spectrometry may be obtained by plotting the change in the ion signal ratio obtained by repeating the steps (i)-(iii) multiple times after obtaining the MALDI mass spectra having the same total ion count (TIC) against the change in the concentration ratio and conducting linear regression analysis.

As described above, the fact that the analyte-to-matrix ion signal ratio is determined by the temperature (T_{early}) means that the proton exchange reaction is at thermal equilibrium. Whether the reaction of Reaction Formula (1) is at thermal equilibrium can be identified by investigating whether the reaction quotient (Q) at the same T_{early} changes with the analyte concentration in samples with different analyte concentrations.

The inventors of the present disclosure have obtained spectra having the same T_{early} but having different composition of the sample by selecting only the MALDI mass spectra having the same total ion count (TIC), i.e. a specific T_{early}. In addition, the inventors of the present disclosure have measured the intensities of the ions derived from the matrix and the analyte for the obtained spectra.

As a result of calculating the reaction quotient by substituting the value obtained by dividing the analyte ion signal intensity by the matrix ion signal intensity (ion signal ratio) and the matrix concentration and the analyte concentration of the sample into Equation (3), the inventors of the present disclosure have found out that the reaction quotient is constant if T_{early} is the same, even when the concentration of the analyte included in the sample is different. This result means that the reaction of Reaction Formula (1) is at thermal equilibrium.

Because the proton exchange reaction between the matrix and the analyte is at equilibrium, the reaction quotient (Q) in Equations (2) and (3) can be replaced by the equilibrium constant (K). Then, Equations (2) and (3) can be written as Equation (4).

K=[M][AH⁺]/([MH⁺][A])=([AH⁺]/[MH⁺])/([A]/[M])=(I_{AH+}/I_{MH+})/([A]/[M]) (4)

Because the amount of ions in the MALDI plume is much smaller than that of neutral molecules, it can be assumed that the ratio [A]/[M] in a solid sample is the same in the MALDI plume. From Equation (4), calibration equations are obtained as Equation (5) or (6).

[AH⁺][MH⁺]=K([A]/[M]) (5)

I_{AH+}/I_{MH+}=K([A]/[M]) (6)

From Equation (6), the slope of the calibration curve, i.e. the equilibrium constant, can be obtained with only one I_{AH+}/I_{MH+} measurement value and one [A]/[M] value.

In addition, the slope of the calibration curve of Equation (6), i.e. the equilibrium constant, can also be obtained through statistical treatment, i.e. regression analysis, of multiple I_{AH+}/I_{MH+} measurement values and multiple [A]/[M] values. In this case, a more accurate equilibrium constant can be obtained than when only one I_{AH+}/I_{MH+} measurement value and one [A]/[M] value are used.

In an exemplary embodiment of the present disclosure, a line with a slope K can be obtained with I_{AH+}/I_{MH+} (i.e., [AH⁺]/[MH⁺]) as the ordinate and [A]/[M] as the abscissa. This line is the calibration curve (or calibration equation) for MALDI mass spectrometry.

The fourth object of the present disclosure can be achieved by providing a method for quantitative analysis of an analyte using MALDI mass spectrometry, including: (i) selecting only the mass spectra having the same total ion count from among multiple mass spectra obtained from ions generated by applying energy to a sample having an analyte mixed therein; (ii) measuring the value obtained by dividing the signal intensity of the analyte ion by the signal intensity of the matrix ion (ion signal ratio) from the MALDI mass spectra obtained in the step (i); and (iii) calculating the molar concentration of the analyte by substituting the molar concentration of the matrix and the ion signal ratio obtained in the step (ii) into the calibration curve for MALDI mass spectrometry.

In the method for quantitative analysis of an analyte using MALDI mass spectrometry of the present disclosure, a means of applying energy to the sample may be a laser, a particle beam or other forms of radiation. The laser may be a nitrogen laser or a Nd:YAG laser. The laser may be irradiated to one spot of the sample multiple times or may be irradiated to multiple spots of the sample to obtain multiple spectra of the analyte ion.

As can be seen from Equation (6), I_{AH+}/I_{MH+} is proportional to [A]/[M]. This means that the amount of the analyte in the solid sample can be measured by measuring I_{AH+}/I_{MH+} from the MALDI mass spectra. Equation (6) can be written as Equation (7).

[A]=(I_{AH+}/I_{MH+})[M]/K=(I_{AH+}/I_{MH+})[M]/Q (7)

That is to say, in quantitative analysis using MALDI mass spectrometry, Equation (7) can be used as a calibration curve (or calibration equation) for obtaining the absolute amount of the analyte.

More specifically, the analyte concentration [A] can be calculated from the calibration curve (Equation (7)) obtained in the method for obtaining a calibration curve for MALDI mass spectrometry of the present disclosure using the ratio of the analyte ion signal intensity and the matrix ion signal intensity, i.e. I_{AH+}/I_{MH+}, obtained in the step (iii) of the method for quantitative analysis of an analyte using MALDI mass spectrometry of the present disclosure and the matrix concentration [M].

Since the equilibrium state of a chemical reaction is maintained even when another chemical reaction is also at equilibrium, Equation (7) holds for each component in the matrix plume. That is to say, the method of the present disclosure using MALDI-TOF mass spectra is applicable to quantitative analysis of a specific analyte even when the analyte or a sample is severely contaminated. Accordingly, the method of the present disclosure allows for quantitative analysis of various components of a mixture at the same time.

The another object of the present disclosure can be achieved by providing a novel use of a matrix material for quantitative analysis of an analyte using MALDI mass spectrometry.

In the present disclosure, the term “matrix” refers to a material which absorbs energy from an energy source such as a laser and transfers the energy to an analyte, thereby heating and ionizing the analyte. As the matrix used in MALDI mass spectrometry, various materials are known, including CHCA (α-cyano-4-hydroxycinnamic acid), DHB (2,5-dihydroxybenzoic acid), sinapinic acid, 4-hydroxy-3-methoxycinnamic acid, picolinic acid, 3-hydroxypicolinic acid, 2,6-dihydroxyacetophenone, 1,5-diaminonapthalene, 2,4,6-trihydroxyacetophenone, 2-(4′-hydroxybenzeneazo)benzoic acid, 2-mercaptobenzothiazole, chlorocyanocinnamic acid and fluorocyanocinnamic acid.

The another object of the present disclosure can be achieved by providing a method for quantitative analysis including a step obtaining multiple MALDI mass spectra from ions generated by applying energy to a sample having an analyte mixed therein.

A matrix used in the method of the present disclosure may be selected from CHCA (α-cyano-4-hydroxycinnamic acid), DHB (2,5-dihydroxybenzoic acid), sinapinic acid, 4-hydroxy-3-methoxycinnamic acid, picolinic acid, 3-hydroxypicolinic acid, 2,6-dihydroxyacetophenone, 1,5-diaminonapthalene, 2,4,6-trihydroxyacetophenone, 2-(4′-hydroxybenzeneazo)benzoic acid, 2-mercaptobenzothiazole, chlorocyanocinnamic acid or fluorocyanocinnamic acid.

In the method of the present disclosure, a means of applying energy to the sample may be a laser, a particle beam or other forms of radiation. The laser may be a nitrogen laser or a Nd:YAG laser.

In the method of the present disclosure, the laser may be irradiated to one spot of the sample multiple times or may be irradiated to multiple spots of the sample.

In an exemplary embodiment, the present disclosure provides a method for measuring the equilibrium constant of a proton exchange reaction between a matrix and an analyte at constant temperature, including: (i) selecting only the mass spectra having the same fragmentation pattern of an analyte ion or a matrix ion from among multiple mass spectra obtained from ions generated by applying energy to a sample having a predetermined amount of a matrix and a predetermined amount of an analyte mixed therein; and (ii) measuring the value obtained by dividing the signal intensity of the analyte ion by the signal intensity of the matrix ion (ion signal ratio) from the MALDI mass spectra selected in the step (i), wherein the ion signal ratio is divided by the value obtained by dividing the concentration of the analyte by the concentration of the matrix (concentration ratio) to obtain the equilibrium constant.

In another exemplary embodiment, the present disclosure provides a method for measuring the equilibrium constant of a proton exchange reaction between a matrix and an analyte at constant temperature, including: (i) selecting only the mass spectra having the same fragmentation pattern of a matrix ion from among multiple mass spectra obtained from ions generated by applying energy to a sample having a predetermined amount of a matrix, a predetermined amount of an analyte and a third material mixed therein; and (ii) measuring the value obtained by dividing the signal intensity of the analyte ion by the signal intensity of the matrix ion (ion signal ratio) from the MALDI mass spectra selected in the step (i), wherein the ion signal ratio is divided by the value obtained by dividing the concentration of the analyte by the concentration of the matrix (concentration ratio) to obtain the equilibrium constant.

In the method for measuring the equilibrium constant of a proton exchange reaction between a matrix and an analyte at constant temperature according to this exemplary embodiment, a means of applying energy to the sample may be a laser, a particle beam or other forms of radiation. The laser may be a nitrogen laser or a Nd:YAG laser. Specifically, the laser may be irradiated to one spot of the sample multiple times or may be irradiated to multiple spots of the sample to obtain multiple spectra of the analyte ion.

In typical MALDI mass spectrometry, a laser pulse is irradiated to a solid sample consisting of a matrix (M) and a trace amount of an analyte (A). The matrix helps the absorption of the laser and, thus, the heating and ionization of the analyte. The resulting MALDI mass spectrum is a spectrum of a fragmented mixture of a matrix ion and an analyte ion.

In the present disclosure, the term “plume” refers to a vapor generated from a sample by the energy of a laser pulse irradiated to the sample. The plume contains gaseous matrix molecules, analyte molecules, matrix ions and analyte ions. Among them, the gaseous matrix molecules constitute the most part of the plume.

In the present disclosure, the term “reaction quotient” is defined as Q=I[C]^{c}[D]^{d})/([A]^{a}[B]^{b}) for a reaction aA+bB→cC+dD. When the chemical reaction is at equilibrium, the reaction quotient is equal to the equilibrium constant.

In the present disclosure, the term “calibration curve” or “calibration equation” refers to an empirically obtained curve about the relationship between the concentration of a component and the particular property of the component (e.g., electrical property, color development, etc.). The calibration curve is used for quantitative analysis of a component with an unknown concentration.

In the present disclosure, the term “ion signal ratio” is defined as the value obtained by dividing the signal intensity of an analyte ion (I_{AH+}) by the signal intensity of a matrix ion (I_{MH+}). And, in the present disclosure, the term “concentration ratio” is defined as the value obtained by dividing the moles of an analyte contained in a sample by the moles of a matrix contained in the sample ([A]/[M]).

The ions appearing on a MALDI mass spectrum are protonated analyte (AH⁺), protonated matrix (MH⁺) and fragmented products thereof generated in an ion source. Accordingly, the pattern of a MALDI mass spectrum is determined by fragmentation pattern of AH+ and MH+ and the analyte-to-matrix ion ratio.

The inventors of the present disclosure have invented and reported a method for determining the temperature of the early plume (T_{early}) generated by MALDI (Bae, Y. J.; Moon, J. H.; Kim, M. S. J. Am. Soc. Mass Spectrom. 2011, 22, 1070-1078; Yoon, S. H.; Moon, J. H.; Kim, M. S. J. Am. Soc. Mass Spectrom. 2010, 21, 1876-1883). The inventors of the present disclosure have also found out that the three factors are determined if T_{early} is specified.

In addition, the inventors of the present disclosure have found out that, although the early plume temperature (T_{early}) varies if the MALDI experimental condition is changed in MALDI mass spectrometry, the mass spectra with the same T_{early} exhibit the same mass spectral patterns. This phenomenon occurs also in the case where the sample contains the matrix and a third material in addition to the analyte.

Therefore, the inventors of the present disclosure could improve the reproducibility of the ion fragmentation patterns of MALDI mass spectra by selecting only the mass spectra having the same fragmentation patterns of a matrix ion, an analyte ion or an added third material ion included in the MALDI mass spectrometry sample after measuring the MALDI mass spectra multiple times under different experimental conditions and comparing the fragmentation patterns.

In a MALDI plume, a proton exchange reaction occurs between the matrix and the analyte as described in Reaction Formula (1):

MH⁺+A→M+AH⁺ (1)

The reaction quotient of Reaction Formula (1) is defined by Equation (2).

Q=[M][AH⁺]/([MH⁺][A])=([M]/[A])/([MH⁺]/[AH⁺]) (2)

In Equation (2), [M]/[A] can be obtained directly from the concentrations of the matrix and the analyte used for preparation of the sample.

And, in Equation (2), [AH⁺]/[MH⁺] is the value obtained by dividing the concentration of the ions derived from the analyte by the concentration of the ions derived from the matrix and is equal to the value obtained by dividing the signal intensity of the analyte-derived ions by the signal intensity of the matrix-derived ions (ion signal ratio), i.e. I_{AH+}/I_{MH+}, obtained in the step (ii) of the method for measuring the reaction quotient of a proton exchange reaction of the present disclosure. Then, Equation (2) can be written as follows.

Q=([M]/[A])/(I_{AH+}/I_{MH+}) (3)

Since both the [M]/[A] value and the I_{AH+}/I_{MH+} value in Equation (3) can be obtained, the reaction quotient of a proton exchange reaction between the matrix and the analyte can be obtained. And, since this reaction is in equilibrium, the reaction quotient is equal to the equilibrium constant.

In another exemplary embodiment, the present disclosure provides a method for obtaining a calibration curve for MALDI mass spectrometry, including: (i) selecting only the MALDI mass spectra having the same fragmentation pattern of an analyte ion or a matrix ion from among multiple MALDI mass spectra obtained from ions generated by applying energy to a sample having a predetermined amount of a matrix and a predetermined amount of an analyte mixed therein; (ii) measuring the value obtained by dividing the signal intensity of the analyte ion by the signal intensity of the matrix ion (ion signal ratio) from the MALDI mass spectra obtained in the step (i); and (iii) obtaining a calibration curve for MALDI mass spectrometry by plotting the ion signal ratio against the concentration of the analyte divided by the concentration of the matrix (concentration ratio).

In another exemplary embodiment, the present disclosure provides a method for obtaining a calibration curve for MALDI mass spectrometry, including: (i) selecting only the MALDI mass spectra having the same fragmentation pattern of a third material ion from among multiple MALDI mass spectra obtained from ions generated by applying energy to a sample having a predetermined amount of a matrix, a predetermined amount of an analyte and a third material mixed therein; (ii) measuring the value obtained by dividing the signal intensity of the analyte ion by the signal intensity of the matrix ion (ion signal ratio) from the MALDI mass spectra obtained in the step (i); and (iii) obtaining a calibration curve for MALDI mass spectrometry by plotting the ion signal ratio against the concentration of the analyte divided by the concentration of the matrix (concentration ratio).

In the method for obtaining a calibration curve for MALDI mass spectrometry according to this exemplary embodiment of the present disclosure, a means of applying energy to the sample may be a laser, a particle beam or other forms of radiation. The laser may be a nitrogen laser or a Nd:YAG laser. Specifically, the laser may be irradiated to one spot of the sample multiple times or may be irradiated to multiple spots of the sample.

Also, in the method for obtaining a calibration curve for MALDI mass spectrometry according to this exemplary embodiment, the calibration curve for MALDI mass spectrometry may be obtained by plotting the change in the ion signal ratio obtained by repeating the steps (i)-(iii) multiple times after obtaining the MALDI mass spectra having the same total ion count (TIC) while keeping the concentration of the matrix constant against the change in the concentration ratio and conducting linear regression analysis.

As described above, the fact that the analyte-to-matrix ion signal ratio is determined by the temperature (T_{early}) means that the proton exchange reaction is at thermal equilibrium. Whether the reaction of Reaction Formula (1) is at thermal equilibrium can be identified by investigating whether the reaction quotient (Q) at the same T_{early} changes with the analyte concentration in samples with different analyte concentrations.

The inventors of the present disclosure have obtained spectra having the same T_{early} but having different composition of the sample by selecting only the MALDI mass spectra having the same total ion count (TIC), i.e. a specific T_{early}, after obtaining MALDI mass spectra by repeatedly irradiating a laser pulse to multiple samples having different analyte concentrations. In addition, the inventors of the present disclosure have measured the intensities of the ions derived from the matrix and the analyte for the obtained spectra.

As a result of calculating the reaction quotient by substituting the value obtained by dividing the analyte ion signal intensity by the matrix ion signal intensity (ion signal ratio) and the matrix concentration and the analyte concentration of the sample into Equation (3), the inventors of the present disclosure have found out that the reaction quotient is constant if T_{early} is the same, even when the concentration of the analyte included in the sample is different. This result means that the reaction of Reaction Formula (1) is at thermal equilibrium.

Because the proton exchange reaction between the matrix and the analyte is at equilibrium, the reaction quotient (Q) in Equations (2) and (3) can be replaced by the equilibrium constant (K). Then, Equations (2) and (3) can be written as Equation (4).

K=[M][AH⁺]/([MH⁺][A])=([AH⁺]/[MH⁺])/([A]/[M])=(I_{AH+}/I_{MH+})/([A]/[M]) (4)

Because the amount of ions in the MALDI plume is much smaller than that of neutral molecules, it can be assumed that the ratio [A]/[M] in a solid sample is the same in the MALDI plume. From Equation (4), calibration equations are obtained as Equation (5) or (6).

[AH⁺]/[MH⁺]=K([A]/[M]) (5)

I_{AH+}/I_{MH+}=K([A]/[M]) (6)

From Equation (6), the slope of the calibration curve, i.e. the equilibrium constant, can be obtained with only one I_{AH+}/I_{MH+} measurement value and one [A]/[M] value.

In addition, the slope of the calibration curve of Equation (6), i.e. the equilibrium constant, can also be obtained through statistical treatment, i.e. regression analysis, of multiple I_{AH+}/I_{MH+} measurement values and multiple [A]/[M] values. In this case, a more accurate equilibrium constant can be obtained than when only one I_{AH+}/I_{MH+} measurement value and one [A]/[M] value are used.

In an exemplary embodiment of the present disclosure, a line with a slope K can be obtained with I_{AH+}/I_{MH+} (i.e., [AH⁺]/[MH⁺]) as the ordinate and [A]/[M] as the abscissa. This line is the calibration curve (or calibration equation) for MALDI mass spectrometry.

In an exemplary embodiment, the present disclosure provides a use of a matrix for use in a method for quantitative analysis comprising: (i) selecting only the mass spectra having the same fragmentation pattern of an analyte ion from among multiple mass spectra obtained from ions generated by applying energy to a sample having a predetermined amount of a matrix and an unknown amount of an analyte mixed therein; (ii) measuring the value obtained by dividing the signal intensity of the analyte ion by the signal intensity of the matrix ion (ion signal ratio) from the MALDI mass spectra selected in the step (i); and (iii) calculating the molar concentration of the analyte by substituting the molar concentration of the matrix and the ion signal ratio obtained in the step (ii) into a calibration curve for MALDI mass spectrometry of Equation (7).

[A]=(I_{AH+}/I_{MH+})[M]/K (7)

In another exemplary embodiment, the present disclosure provides a use of a matrix for use in a method for quantitative analysis comprising: (i) selecting only the mass spectra having the same fragmentation pattern of a matrix ion from among multiple mass spectra obtained from ions generated by applying energy to a sample having a predetermined amount of a matrix and an unknown amount of an analyte mixed therein; (ii) measuring the value obtained by dividing the signal intensity of the analyte ion by the signal intensity of the matrix ion (ion signal ratio) from the MALDI mass spectra selected in the step (i); and (iii) calculating the molar concentration of the analyte by substituting the molar concentration of the matrix and the ion signal ratio obtained in the step (ii) into a calibration curve for MALDI mass spectrometry of Equation (7).

[A]=(I_{AH+}/I_{MH+})[M]/K (7)

In another exemplary embodiment, the present disclosure provides a use of a matrix for use in a method for quantitative analysis comprising: (i) selecting only the mass spectra having the same fragmentation pattern of a matrix ion from among multiple mass spectra obtained from ions generated by applying energy to a sample having a predetermined amount of a matrix and a third material and an unknown amount of an analyte mixed therein; (ii) measuring the value obtained by dividing the signal intensity of the analyte ion by the signal intensity of the matrix ion (ion signal ratio) from the MALDI mass spectra selected in the step (i); and (iii) calculating the molar concentration of the analyte by substituting the molar concentration of the matrix and the ion signal ratio obtained in the step (ii) into a calibration curve for MALDI mass spectrometry of Equation (7).

[A]=(I_{AH+}/I_{MH+})[M]/K (7)

In the method for quantitative analysis of an analyte using MALDI mass spectrometry according to an exemplary embodiment of the present disclosure, a means of applying energy to the sample may be a laser, a particle beam or other forms of radiation. The laser may be a nitrogen laser or a Nd:YAG laser. Specifically, the laser may be irradiated to one spot of the sample multiple times or may be irradiated to multiple spots of the sample.

As can be seen from Equation (6), I_{AH+}/I_{MH+} is proportional to [A]/[M]. This means that the amount of the analyte in the solid sample can be measured by measuring I_{AH+}/I_{MH+} from the MALDI mass spectra. Equation (6) can be written as Equation (7).

[A]=(I_{AH+}/I_{MH+})[M]/K=(I_{AH+}/I_{MH+})[M]/Q (7)

That is to say, in quantitative analysis using MALDI mass spectrometry, Equation (7) can be used as a calibration curve (or calibration equation) for obtaining the absolute amount of the analyte.

More specifically, the analyte concentration [A] can be calculated from the calibration curve (Equation (7)) obtained in the method for obtaining a calibration curve for MALDI mass spectrometry according to an exemplary embodiment of the present disclosure using the ratio of the analyte ion signal intensity and the matrix ion signal intensity, i.e. I_{AH+}/I_{MH+}, obtained in the step (iii) of the method for quantitative analysis of an analyte using MALDI mass spectrometry of the present disclosure and the matrix concentration [M].

Since the equilibrium state of a chemical reaction is maintained even when another chemical reaction is also at equilibrium, Equation (7) holds for each component in the matrix plume. That is to say, the method of the present disclosure using MALDI-TOF mass spectra is applicable to quantitative analysis of a specific analyte even when the analyte or a sample is severely contaminated. Accordingly, the method of the present disclosure allows for quantitative analysis of various components of a mixture at the same time.

In an exemplary embodiment of the present disclosure, MALDI mass spectrometry may be conducted using a dual track TOF (time-of-flight) mass spectrometer. By using the dual track TOF mass spectrometer, the problem of detector saturation due to matrix-derived ion signals can be overcome.

For example, two detectors may be used to detect the matrix-derived ions and the peptide- or protein-derived ions separately. From the spectra obtained using the dual track TOF mass spectrometer, a better calibration curve can be obtained and, accordingly, a more accurate quantitative analysis is possible.

### Advantageous Effects

The method of the present disclosure can solve the reproducibility problem of the existing MALDI mass spectrometric technique by selecting only the MALDI spectra having the same total ion count (TIC).

Also, in accordance with the present disclosure, an accurate and fast quantitative analysis of a trace amount of an analyte is possible using MALDI mass spectrometry at low cost.

Also, the dual track MALDI-TOF mass spectrometric technique of the present disclosure can solve the detector saturation problem.

In addition, in accordance with the present disclosure, quantitative analysis using MALDI mass spectrometry is possible even when the analyte is a component of a mixture or when it is severely contaminated.

### BRIEF DESCRIPTION OF DRAWINGS

FIG. 1 shows MALDI spectra averaged in Example 3 over the shot number ranges of (a) 31-40, (b) 81-90 and (c) 291-300 of a laser pulse to one spot of a sample containing 10 pmol of Y₅K (SEQ ID NO: 1) in 25 nmol of CHCA, obtained in Example 3.

FIG. 2 shows TIC-selected MALDI spectra obtained in Example 3 after irradiating a laser pulse with (a) two times, (b) three times and (c) four times the threshold pulse energy to a vacuum-dried sample containing 10 pmol of Y₅K (SEQ ID NO: 1) in 25 nmol of CHCA.

FIG. 3 shows a calibration curve in CHCA-MALDI of Y₅K (SEQ ID NO: 1) obtained in Example 3 by TIC selection (900±180 ions/pulse).

FIG. 4 schematically describes a method of obtaining the early plume temperature (T_{early}) of a peptide ion [Y₆+H]+ (“Y₆” disclosed as SEQ ID NO: 2) in Example 4.

FIG. 5 shows MALDI spectra obtained in Example 5 by repeatedly irradiating a 337-nm laser pulse to one spot of a solid sample containing 3 pmol of Y₅R (SEQ ID NO: 3) in 25 nmol of CHCA (α-cyano-4-hydroxycinnamic acid).

FIG. 6 shows MALDI spectra obtained in Example 5 by repeatedly irradiating a 337-nm laser pulse to one spot of a solid sample containing 3 pmol of Y₅K (SEQ ID NO: 1) in 25 nmol of CHCA.

FIG. 7 shows MALDI spectra obtained in Example 5 by repeatedly irradiating a 337-nm laser pulse to one spot of a solid sample containing 3 pmol of angiotensin II (DRVYIHPF (SEQ ID NO: 4)) in 25 nmol of CHCA.

FIG. 8 shows the change of early plume temperature (T_{early}) depending on the sample thickness in Example 6.

FIG. 9 shows a PSD spectrum of [CHCA+H]⁺ obtained in Example 7.

FIG. 10 shows the MALDI spectra having T_{early} near 968 K among the spectra obtained from a sample with Y₅R:CHCA=1:8300 (“Y₅R” disclosed as SEQ ID NO: 3) in Example 8.

FIG. 11 shows the MALDI spectra having T_{early} near 968 K among the spectra obtained from a sample with Y₅K:CHCA=1:8300 (“Y₅K” disclosed as SEQ ID NO: 1) in Example 8.

FIG. 12 shows the MALDI spectra having T_{early} near 968 K among the spectra obtained from a sample with angiotensin II (DRVYIHPF):CHCA=1:8300 (“DRVYIHPF” disclosed as SEQ ID NO: 4) in Example 8.

FIG. 13 shows the reaction quotients of proton exchange reactions of Y₅R (SEQ ID NO: 3) and Y₅K (SEQ ID NO: 1) with a matrix obtained in Example 9.

FIGS. 14a-14d show calibration curves for MALDI mass spectrometry for Y₅R (SEQ ID NO: 3) and Y₅K (SEQ ID NO: 1) obtained in Example 10.

FIG. 15 shows a MALDI spectrum of a mixture sample of nine peptides (SEQ ID NOS 5, 1, 8, 3, 4 and 9-12, respectively, in order of appearance), tamoxifen and a matrix obtained in Example 11.

FIG. 16 schematically shows a track MALDI-TOF instrument used in Example 12.

FIG. 17 shows pulsing schemes for (a) an ordinary mass spectrometric mode and (b) a tandem mass spectrometric mode used in Example 12.

FIG. 18 shows temperature-controlled CHCA-MALDI spectra obtained in Example 12 by irradiating a laser pulse in an ordinary mass spectrometric mode over the shot number ranges of (a) 31-40 and (b) 101-110 and temperature-controlled CHCA-MALDI spectra obtained in Example 12 by irradiating a laser pulse in a tandem mass spectrometric mode (mode over the shot number ranges of c) 31-40 and (d) 101-110 (∘: ISD peaks, •: PSD peaks). Figure discloses “Y₅K” as SEQ ID NO: 1.

FIGS. 19a and 19b show calibration curves for (a) Y₅K (SEQ ID NO: 1) and (b) angiotensin II obtained in Example 12 by plotting I([P+H]⁺)/I([M+H]) vs. c(P) data obtained for samples containing 0.03-30 pmol of Y5K (SEQ ID NO: 1) in 25 nmol of CHCA in a tandem mass spectrometric mode.

FIG. 20 shows CHCA-MALDI spectra of samples containing trypsinogen, protein A and BSA obtained by dual track TOF mass spectrometry in Example 12. For control of temperature, the [CHCA+H−CO₂]+-to-[CHCA+H−H₂O]+ ratio was set to 0.15.

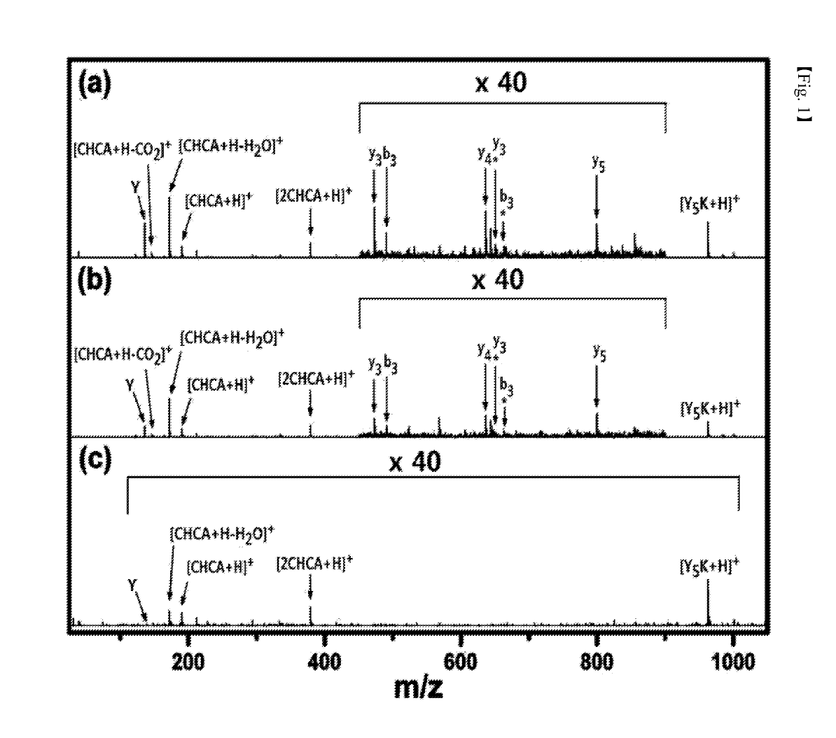

### BEST MODE FOR CARRYING OUT INVENTION

Hereinafter, the present disclosure will be described in detail through examples. However, the following examples are for illustrative purposes only and it will be apparent to those of ordinary skill in the art that the scope of the present disclosure is not limited by the examples.

Experiments on Method for Obtaining Mass Spectrum of Ions Generated at Constant Temperature by Measuring Total Ion Count

In the following examples, a MALDI-TOF mass spectrometer developed by the inventors of the present disclosure was used (Bae, Y. J.; Shin, Y. S.; Moon, J. H.; Kim. M. S. J. Am. Soc. Mass Spectrom. 2012, 23, 1326-1335; Bae, Y. J.; Yoon, S. H.; Moon, J. H.; Kim, M. S. Bull. Korean Chem. Soc. 2010, 31, 92-99; Yoon, S. H.; Moon, J. H.; Choi, K. M.; Kim, M. S. Rapid Commun Mass Spectrom. 2006, 20, 2201-2208). The MALDI-TOF mass spectrometer was composed of an ion source with delayed extraction, a linear TOF analyzer, a reflectron and a detector. The 337-nm output from a nitrogen laser (MNL100, Lasertechnik Berlin, Berlin, Germany) focused by a lens with a focal length of 100 mm was used for MALDI. The threshold pulse energy at the sample position was 0.30 and 1.4 μJ/pulse for CHCA (α-cyano-4-hydroxycinnamic acid) and DHB (2,5-dihydroxybenzoic acid), respectively. To improve the signal-to-noise ratio, the obtained spectral data were averaged over 10 laser shots.

### Example 1

### Sample Preparation

As analytes, peptides Y6 (SEQ ID NO: 2), Y5K (SEQ ID NO: 1) and angiotensin II (DRVYIHPF (SEQ ID NO: 4)) were purchased from Peptron (Daejeon, Korea). Matrices CHCA and DHB were purchased from Sigma (St. Louis, Mo., USA). An aqueous solution of the analyte was mixed with a 1:1 water/acetonitrile solution of CHCA or DHB. In CHCA-MALDI, 1 μL of a solution containing 0-250 pmol of the analyte and 25 nmol of CHCA was loaded on the target and vacuum- or air-dried. Sampling for DHB-MALDI of Y₆ (SEQ ID NO: 2) was carried out in two steps. In each step, 1 μL of a solution containing 0.5-320 pmol of Y₆ (SEQ ID NO: 2) in 50 nmol of DHB was loaded on the target and vacuum-dried.

### Example 2

### Measure of Spectral Temperature—Total Ion Count (TIC)

Kinetic analysis of the fragmentation of the analyte ion is not necessary for measurement of T_{early} in the MALDI spectrum. Rather, the fragmentation pattern of the matrix ion or the total number of generated ions can also be used as a measure (indicator) of T_{early}. However, for these methods, it is not easy to calculate the T_{early} if the identity, concentration or number of the analytes vary. Therefore, for practical quantitative analysis, a good measure of T_{early} which allows for easy and fast calculation of T_{early} regardless of the identity, concentration or number of the analytes is necessary. A good measure of T_{early} should satisfy the following criteria.

First, a measure of T_{early} must be a sensitive function of T_{early}. Second, the measure of T_{early} must be independent of the identities of the analytes, the concentrations of the analytes in a solid sample, and their numbers. Third, it should be possible to compute this property rapidly and straightforwardly from a spectrum.

The measurement of T_{early} based on the fragmentation of analyte ion does not satisfy the second and third criteria. Also, when the fragmentation pattern of the matrix ion is used, the measurement of T_{early} is difficult if the matrix ion signal is contaminated. The first and second criteria can be satisfied if the total number of ions generated in MALDI is used as a measure of T_{early}.

However, because it is not easy to count the total number of ions generated inside a reflectron due to loss of fragmentation products, the inventors of the present disclosure have defined the total number of particles detected by a detector as total ion count (TIC) and used it as a measure of T_{early}. To confirm that TIC is a function of T_{early}, the total number of ions generated per laser pulse and TIC when 25 nmol of CHCA was used as a matrix and the identities, concentrations and numbers of the analytes were varied were listed in Table 1.

TABLE 1
TIC versus analyte concentration in CHCA-MALDI

| | Analyte concentration | TIC per laser pulse^{b} | |
|---|---|---|---|
| Analyte | (pmol)^{a} | T_{early} = 875 ± 5 K | T_{early} = 900 ± 5 K |
| — ^{c} | 0 | 600 ± 60 | 1250 ± 130 |
| Y₅K | 0.10 | 540 ± 90 | 1300 ± 80 |
| (SEQ ID | 1.0 | 450 ± 50 | 1100 ± 110 |
| NO: 1) | 10 | 460 ± 50 | 1070 ± 70 |
| Y₅R | 0.10 | 540 ± 50 | 1220 ± 40 |
| (SEQ ID | 1.0 | 530 ± 160 | 1250 ± 130 |
| NO: 3) | 10 | 520 ± 100 | 1050 ± 120 |
| Mixture^{d} | 1.0/analyte | 580 ± 50 | 1220 ± 30 |

^{a}Picomoles (pmol) of analyte in 25 nmol of CHCA in solid sample.
^{b}Averages over three or more measurements with one standard deviation.
^{c} Pure CHCA.
^{d}0.1 pmol each of Y₅K (SEQ ID NO: 1), Y₅R (SEQ ID NO: 3), YLYEIAR (SEQ ID NO: 5), YGGFL (SEQ ID NO: 6), creatinine and histamine in 25 nmol of CHCA.

From Table 1, it is evident that total ion count (TIC) is very sensitive to the change in T_{early} (875 K→900 K) and is not significantly affected by the identities, concentrations and numbers of the analytes. Accordingly, it can be seen that it can be used as a measure of T_{early} that satisfies the above-described three criteria.

As in CHCA-MALDI, the total number of ions generated per laser pulse was also essentially constant if T_{early} was the same independently of the identity, concentration or number of the analytes in a solid sample in DHB-MALDI. TIC data calculated from the same spectra are listed in Table 2, which suggest that TIC can be used as a measure of T_{early} also in DHB-MALDI.

TABLE 2
TIC versus analyte concentration in DHB-MALDI

| | Analyte concentration | TIC per laser pulse^{b} | |
|---|---|---|---|
| Analyte | (pmol)^{a} | T_{early} = 780 ± 5 K | T_{early} = 800 ± 5 K |
| —^{c} | 0 | 480 ± 40 | 1510 ± 150 |
| Y₆ | 2.0 | 430 ± 70 | 1310 ± 60 |
| (SEQ ID | | | |
| NO: 2) | | | |
| Y₆ | 20 | 460 ± 60 | 1400 ± 130 |
| (SEQ ID | | | |
| NO: 2) | | | |
| Mixture^{d} | 2.0/analyte | 500 ± 100 | 1300 ± 110 |

^{a}Picomoles (pmol) of analyte in 100 nmol of DHB in solid sample.
^{b}Averages over three or more measurements with one standard deviation.
^{c}Pure DHB.
^{d}0.1 pmol each of Y₅K (SEQ ID NO: 1), Y₅R (SEQ ID NO: 3), YLYEIAR (SEQ ID NO: 5), YGGFL (SEQ ID NO: 6), creatinine and histamine in 100 nmol of DHB.

### Example 3

### Quantitative Reproducibility of TIC-Selected Spectra

First, spectral changes occurring upon repetitive irradiation of a laser pulse were investigated. A set of MALDI spectra was taken from one spot of a vacuum-dried sample containing 10 pmol of Y5K (SEQ ID NO: 1) in 25 nmol of CHCA using a laser pulse of two times the threshold pulse energy.

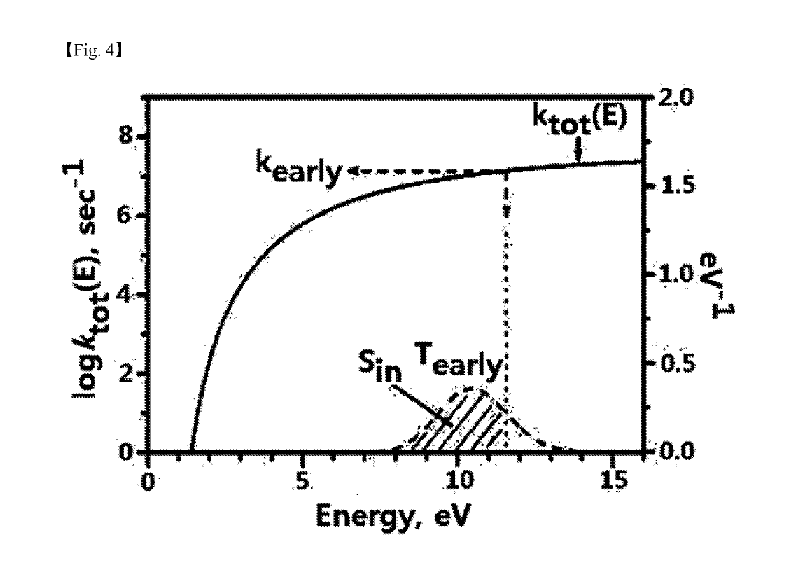

From this set, the spectra averaged over the shot number ranges of 31-40, 81-90 and 291-300 are shown in FIG. 4. The first 30 spectra were not used because contamination by alkali adduct ions was significant in those spectra. The total TICs summed over the above shot number ranges were 12000 (12000), 7300 (58000) and 110 (106000), respectively (The numbers in parentheses denote TICs accumulated in the shot number ranges of 31-40, 81-90 and 291-300, respectively.). Since temperature selection was not made, both the spectral pattern and the abundance of each ion changed as the laser shot continued. At the shot number range of 291-300, [Y₅K+H]⁺ (“Y₅K” disclosed as SEQ ID NO: 1) became more prominent than others. However, the absolute abundance at the shot number range of 291-300 was very low compared to those at the shot number range of 31-40 or 81-90. In fact, ion generation virtually stopped after the shot number 300. This does not mean that materials at the irradiated spot were completely depleted at the shot number 300 because ion generation resumed when the laser pulse energy was raised. This phenomenon occurs for the following reason. As the irradiated spot gets thinner, the temperature at the spot gets lower, eventually becoming lower than the threshold for ablation at the shot number 300. Then, the increase in the laser pulse energy raises the temperature above the ablation threshold and the ion generation resumes.

As previously reported by the inventors of the present disclosure, the MALDI spectra obtained from a sample with a given composition were quantitatively reproducible regardless of the experimental condition when the spectra with the same T_{early} were selected. In this previous work, the I([M+H−H₂O]⁺)/I([M+H]⁺) ratio was used as the measure of T_{early}.

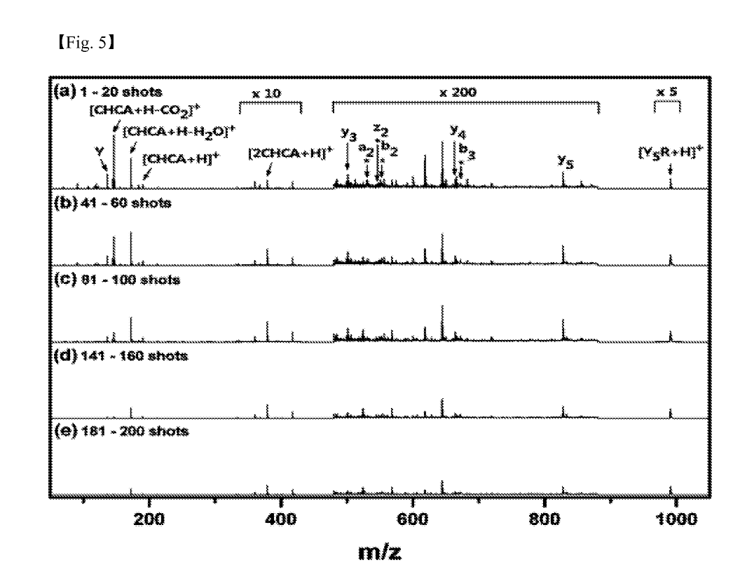

In the present disclosure, a similar measurement was made for a vacuum-dried sample containing 10 pmol of Y₅K (SEQ ID NO: 1) in 25 nmol of CHCA and selected spectra with TIC of 1100±200 ions/pulse. As shown in FIG. 5, the spectra thus obtained were virtually the same. A similar result was obtained also for the sample containing angiotensin II in CHCA. These results indicate that TIC is an excellent measure of T_{early}. Also, as a result of checking the spot-to-spot and sample-to-sample reproducibilities, it was found out that the strategy of spectral acquisition-temperature selection using TIC worked well.

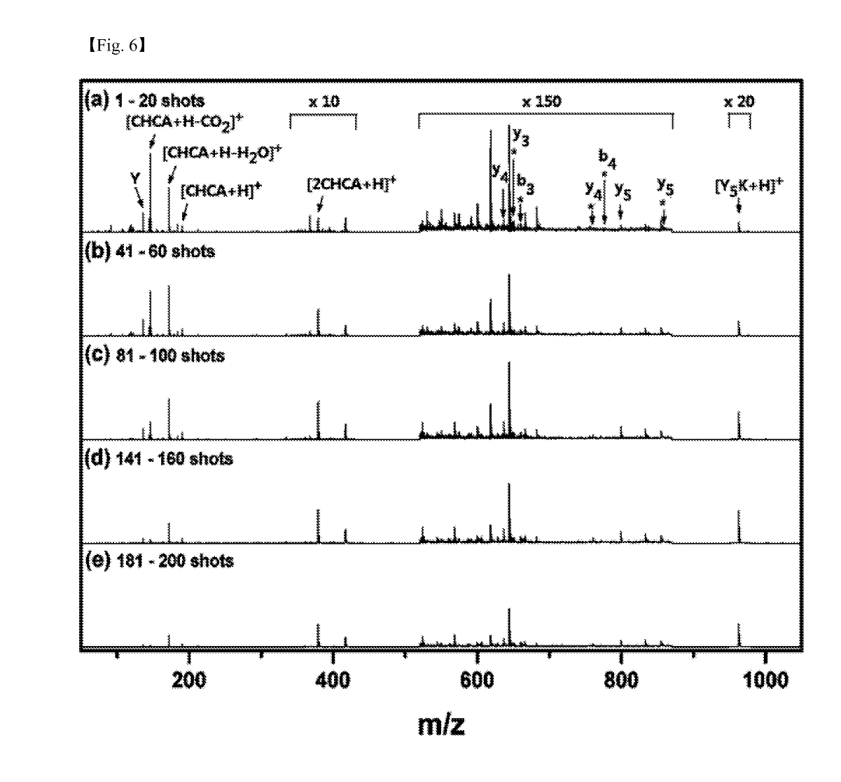

MALDI spectra for vacuum-dried samples containing 0.01-250 pmol of Y₅K (SEQ ID NO: 1) in 25 nmol of CHCA were obtained, the spectra with TIC of 900±180 ions/pulse were selected, and [AH+]/[MH+] versus [A]/[M] data were calculated from the selected spectra. The result is shown in FIG. 6. The excellent linearity of the calibration curve demonstrates the utility of TIC for temperature selection.

Experiments on Use of Matrix for Quantitative Analysis Using MALDI Mass Spectrometry

The MALDI-TOF instrument developed by the inventors of the present disclosure was used (Bae, Y. J.; Shin, Y. S.; Moon, J. H.; Kim. M. S. J. Am. Soc. Mass Spectrom. 2012, 23, 1326-1335; Bae, Y. J.; Yoon, S. H.; Moon, J. H.; Kim, M. S. Bull. Korean Chem. Soc. 2010, 31, 92-99; Yoon, S. H.; Moon, J. H.; Choi, K. M.; Kim, M. S. Rapid Commun Mass Spectrom. 2006, 20, 2201-2208). One of the important aspects of this instrument is that it is equipped with a reflectron with linear-plus-quadratic potential inside (Oh, J. Y.; Moon, J. H.; Kim, M. S. J. Am. Soc. Mass Spectrom. 2004, 15, 1248-1259; Bae, Y. J.; Yoon, S. H.; Moon, J. H.; Kim, M. S. Bull. Korean Chem. Soc. 2010, 31, 92-99). Accordingly, it can detect prompt ions and their ISD and PSD products at the same time (Bae, Y. J.; Moon, J. H.; Kim, M. S. J. Am. Soc. Mass Spectrom. 2011, 22, 1070-1078).

Unless specified otherwise, the 337-nm output from a nitrogen laser (MNL100, Lasertechnik Berlin, Berlin, Germany) focused by a lens with a focal length of 100 mm was used for MALDI. Also, the 355-nm output from a Nd:YAG laser (SL III-10, Continuum, Santa Clara, Calif., USA) focused by the same lens was used.

To improve the signal-to-noise ratio, the obtained spectra were summed over 20 shots. Then, from the spectra obtained for 20 different spots, those with the same shot number were summed. Accordingly, each spot in the final spectrum is a result obtained from 400 laser shots. The number of ions for each peak was calculated according to the reported method (Bae, Y. J.; Shin, Y. S.; Moon, J. H.; Kim. M. S. J. Am. Soc. Mass Spectrom. 2012, 23, 1326-1335; Moon, J. H.; Shin, Y. S.; Bae, Y. J.; Kim, M. S. J. Am. Soc. Mass Spectrom. 2012, 23, 162-170).

In peptide CHCA-MALDI using the 337-nm output, the threshold pulse energy was 0.50 μJ/pulse. Because the laser beam profile was improved, the value was lower than the previously reported value of 0.75 μJ/pulse (Bae, Y. J.; Shin, Y. S.; Moon, J. H.; Kim. M. S. J. Am. Soc. Mass Spectrom. 2012, 23, 1326-1335; Moon, J. H.; Shin, Y. S.; Bae, Y. J.; Kim, M. S. J. Am. Soc. Mass Spectrom. 2012, 23, 162-170). At 355 nm, the threshold pulse energy was 0.40 μJ/pulse.

The peptides Y5X (Y=tyrosine, X=K (lysine) or R (arginine) (SEQ ID NO: 7); Peptron, Daejeon, Korea), angiotensin II (DRVYIHPF (SEQ ID NO: 4); Sigma, St. Louis, Mo., USA) and CHCA (Sigma, St. Louis, Mo., USA) were used as analytes. After preparing an aqueous solution of each peptide of a desired concentration by diluting a stock aqueous solution, it was mixed with a solution of CHCA in water and acetonitrile. 1 μL of each mixture solution was loaded on the target and vacuum-dried. The sample consisted of 1 or 3 pmol of the peptide in 25 nmol of CHCA.

### Example 4

### Method for Obtaining T_{early}

The kinetic method of obtaining the early plume temperature reported by the inventors of the present disclosure was used (Bae, Y. J.; Moon, J. H.; Kim, M. S. J. Am. Soc. Mass Spectrom. 2011, vol 22, 1070-1078; Yoon, S. H.; Moon, J. H.; Kim, M. S. J. Am. Soc. Mass Spectrom. 2010, vol 21, 1876-1883).

First, the relative intensities of the analyte, matrix and ISD and PSD products thereof were measured from MALDI-TOF spectra. From these data, the survival probability of the peptide ion at the ion source exit (Sᵢₙ) and the survival probability at the detector (Sₚₒₛₜ) were calculated. For fragmentation of [Y₆+H]⁺ (“Y₆” disclosed as SEQ ID NO: 2), the total fragmentation rate constant, k(E), of the ions had been already determined by time-resolved photodissociation (Yoon, S. H.; Moon, J. H.; Kim, M. S. J. Am. Soc. Mass Spectrom. 2009, 20, 1522-1529). In kinetic analysis, 50 ns was postulated as the threshold lifetime of ISD, which corresponds to a reaction rate constant of 1.4×10⁷ s⁻¹ and an internal energy of 13.157 eV. Then, the effective temperature in the early plume (T_{early}) was determined such that the area below 13.157 eV in the internal energy distribution becomes Sin. The temperature in the late plume was determined in a similar fashion using a rate constant of 5.4×10⁴ s⁻¹ as the threshold value. Because the laser fluence was higher than the reported value, the determined T_{early} value was rather higher than the 881 K previously reported by the inventors of the present disclosure (Bae, Y. J.; Moon, J. H.; Kim, M. S. J. Am. Soc. Mass Spectrom. 2011, vol. 22, 1070-1078).

To determine the peptide temperature by a kinetic method, it is necessary to know the rate constant k(E) of the fragmentation reaction. The inventors of the present disclosure have shown that k(E) can be obtained by using the method of the present disclosure conversely and reported E₀=0.660 eV and ΔS^{‡}=−27.2 eu (1 eu=4.184 J mol⁻¹ K⁻¹) for the fragmentation reaction of [Y₅R+H]⁺ (“Y₅R” disclosed as SEQ ID NO: 3) and E0=0.630 eV and ΔS^{‡}=−27.6 eu for the fragmentation reaction of [Y₅K+H]⁺ (“Y₅K” disclosed as SEQ ID NO: 1). These parameters were used to calculate the RRKM (Rice-Ramsperger-Kassel-Marcus) rate constant (k(E)) of each peptide ion, and the result can be used to obtain T_{early} under various experimental conditions.

Referring to FIG. 4 relating to the peptide ion [Y₆+H]⁺ (“Y₆” disclosed as SEQ ID NO: 2), the intensity of the related ions occurring in MALDI spectra are measured and the survival probability of the peptide ion in the ion source is determined therefrom. The maximum rate constant at which the peptide ion can survive is determined considering the MALDI measurement conditions. Then, the internal energy distribution of the peptide ion is determined while changing temperature and the temperature the probability of the region below the maximum rate constant is the same as the survival probability is taken.

### Example 5

### Change in Total Spectral Pattern Depending on Shot Number

A set of MALDI spectra was taken by repeatedly acquiring data while irradiating a 337-nm nitrogen laser pulse on one spot of a sample. Part of the spectra obtained by irradiating 200 shots of a laser pulse of six times the threshold pulse energy to a sample containing 3 pmol of Y₅R (SEQ ID NO: 3) in 25 nmol of CHCA is shown in FIG. 5. Each spectrum in FIG. 5 was summed over the shot number ranges of (a) 1-20, (b) 41-60, (c) 81-100, (d) 141-160 and (e) 181-200. Not only the peptide ([Y₅R+H]⁺ (“Y₅R” disclosed as SEQ ID NO: 3)) and matrix ([CHCA+H]⁺) ions, ISD products thereof, e.g., the immonium ion Y produced from the peptide ion, [CHCA+H−H₂O]⁺ and [CHCA+H−CO₂]⁺ produced from the matrix ion and the matrix dimer ion ([2CHCA+H]⁺), also occur in the spectra (PSD peaks were denoted by *). In the spectra, the fragmentation products b and y of the peptide ion and their fragmentation products are also observed, although their intensities are very weak as compared to the immonium Y. The PSD products of the peptide ion are also seen as very small peaks. Most of the small but distinct peaks are derived from the matrix. As seen from FIG. 5, the ions showed change in relative intensities as the shot number was changed. Surprisingly, the change of the spectral pattern depending on the shot number showed reproducibility with a relative error of 10-20 shots only.

As described above, the three factors that characterize the overall pattern of MALDI spectra are the relative intensities of the peptide ion and the matrix ion and the fragmentation patterns of the peptide ion and the matrix ion. As can be seen from FIG. 5, all of these three factors changed as the shot continued. First, the relative intensity of the immonium ion Y derived from the peptide ion decreased gradually (The intensities of other ISD products decreased, too.). Second, the mass spectral pattern of the matrix also changed gradually. In particular, the signal of the [CHCA+H−CO₂]⁺ ion weakened. Third, the peptide-derived ions were relatively more abundant as compared to the CHCA-derived ions.

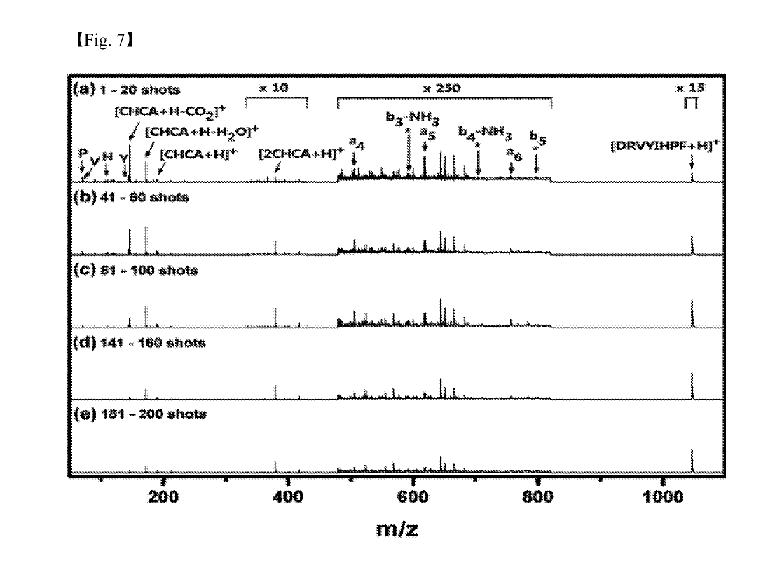

Similar results were observed for Y₅K (SEQ ID NO: 1) (FIG. 6) and angiotensin II (FIG. 7). FIG. 6 shows MALDI spectra obtained by repeatedly irradiating a 337-nm laser pulse to one spot of a solid sample containing 3 pmol of Y₅K (SEQ ID NO: 1) in 25 nmol of CHCA. A laser pulse energy of six times the threshold energy was used and each spectrum was summed over the shot number ranges of (a) 1-20, (b) 41-60, (c) 81-100, (d) 141-160 and (e) 181-200. The immonium Y ion was the major ISD product of [Y₅K+H]⁺ (“Y₅K” disclosed as SEQ ID NO: 1), and [CHCA+H−H₂O]⁺ and [CHCA+H−CO²]+ were the ISD products of [CHCA+H]⁺ (PSD peaks were denoted by *). FIG. 7 shows MALDI spectra obtained by repeatedly irradiating a 337-nm laser pulse to one spot of a solid sample containing 3 pmol of angiotensin II (DRVYIHPF (SEQ ID NO: 4)) in 25 nmol of CHCA. A laser pulse energy of six times the threshold energy was used and each spectrum was summed over the shot number ranges of (a) 1-20, (b) 41-60, (c) 81-100, (d) 141-160 and (e) 181-200. The immonium ions P, V, H and Y were the major ISD products of [DRVYIHPF+H]⁺ (“DRVYIHPF” disclosed as SEQ ID NO: 4), and [CHCA+H−H₂O]⁺ and [CHCA+H−CO₂]+ were the ISD products of [CHCA+H]⁺ (PSD peaks were denoted by *).

### Example 6

### Change in Effective Temperature Depending on Shot Number

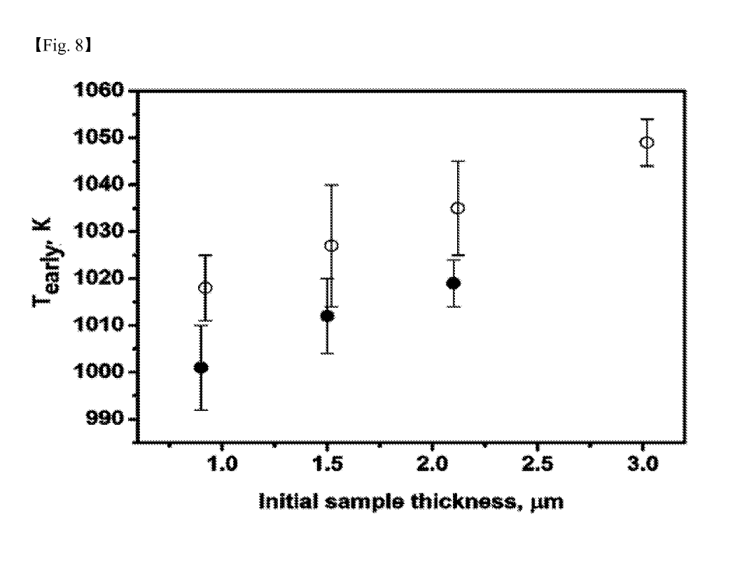

The fact that the relative intensity of the product decreases as the shot continues means that the average internal energy of the peptide decreases. Assuming that the early plume is at thermal equilibrium, this means that T_{early} decreases gradually. One of the events that can occur during continuous irradiation of a laser is that the irradiated spot gets thinner. As the sample gets thinner, T_{early} decreases gradually. To check whether the decrease of T_{early} with the decreased sample thickness is due to the increase in thermal conductivity, samples with the same composition (Y₅R:CHCA=1:25000 (“Y₅R” disclosed as SEQ ID NO: 3)) but different thicknesses (0.9-2.1 μm) were prepared. The sample was prepared on the hydrophobic part of an anchor chip plate coated with a 50-nm thick fluorocarbon layer. A laser pulse of six times the threshold energy was used and the spectra obtained from the first 20 shots were summed. Then, T_{early} was calculated from the Sin measured in each spectrum. The change in T_{early} with the sample thickness is shown in FIG. 8 (stainless steel surface: •, fluorocarbon layer: ∘), which suggests that thermal conduction is more effective as the sample is thinner. The T_{early} of the sample placed on the fluorocarbon layer was higher than that of the sample placed on the exposed metal plate. This means that the fluorocarbon layer acts as a thermal insulator. To conclude, T_{early} can be determined from the fragmentation yield of the peptide ion and the temperature decreases as the laser irradiation continues.

### Example 7

### Change in Fragmentation Pattern of [CHCA+H]⁺ Depending on Shot Number

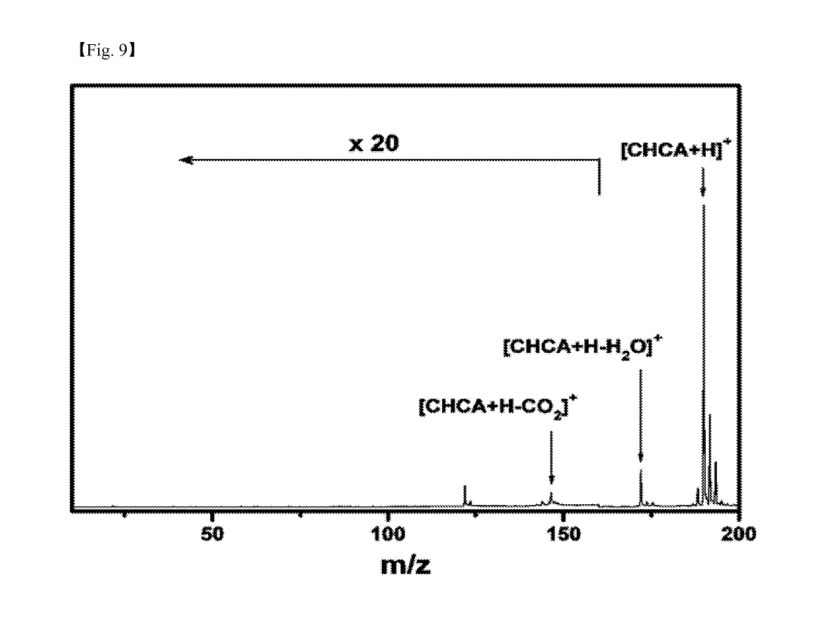

The time scale of PSD (approximately 10 μs) is much longer than the time scale of ISD (tens of nanoseconds). Thus, since the reaction rate of PSD is much slower, a low-energy reaction is more favorable for PSD than for ISD. In the PSD spectrum of [CHCA+H]⁺ (FIG. 9), [CHCA+H−H₂O]⁺ ion was the major product, and the abundance of the [CHCA+H−CO₂]⁺ ion was only 10% of [CHCA+H−H₂O]⁺. This means that the water loss reaction is a lower-energy reaction as compared to the carbon dioxide loss reaction. As seen from the MALDI spectra of FIG. 5, the [CHCA+H−CO₂]⁺ ion generated by ISD decreased as the laser shot continued, as compared to [CHCA+H−H₂O]⁺. This means that the T_{early} decreased as the shot continued. That is to say, the pattern of the CHCA mass spectra is also determined by temperature.

### Example 8

### Peptide-to-Matrix Ion Signal Ratio

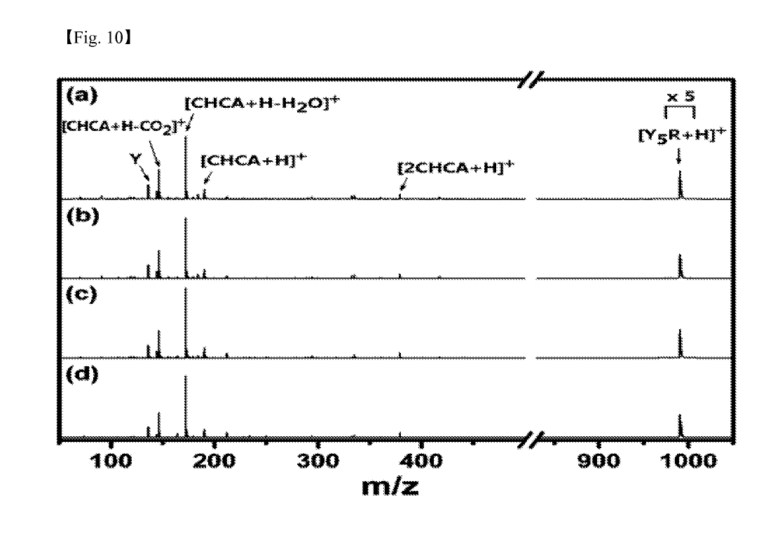

Experiments were carried out under four conditions using samples with Y₅R:CHCA (“Y₅R” disclosed as SEQ ID NO: 3) (peptide-to-matrix ratio)=1:8300. The experimental conditions (# pmol of Y₅R (SEQ ID NO: 3), # nmol of CHCA, times the threshold pulse energy, laser wavelength) were (a) (3, 25, ×6, 337) (shot number ranges of 71-90), (b) (3, 25, ×4, 337) (shot number ranges of 51-70), (c) (4.2, 35, ×6, 337) (shot number ranges of 101-120) and (d) (3, 25, ×6, 355) (shot number ranges of 31-50). From each set, one spectrum with T_{early}=968 K was selected. The selected four spectra are shown in FIG. 10 (a)-(d). It can be seen that the four spectra are virtually the same. This similarity was also observed at other temperatures.

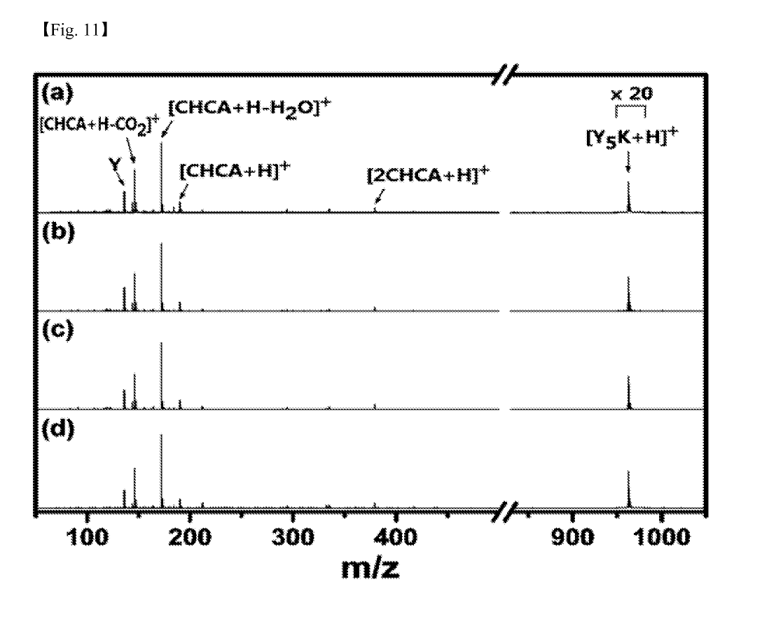

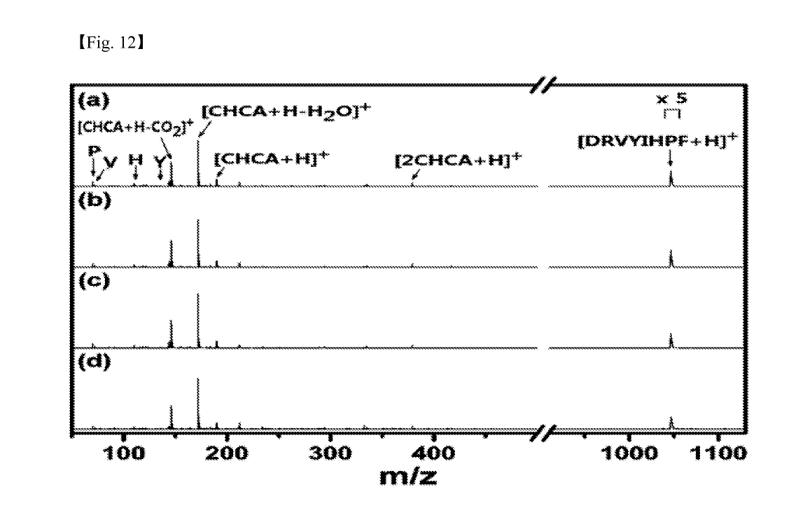

Similar results were observed for Y₅K (SEQ ID NO: 1) (FIG. 11) and angiotensin II (FIG. 12). FIG. 11 shows the spectra with T_{early}≈968 K among the set of the MALDI spectra obtained for samples with Y₅K:CHCA (“Y₅K” disclosed as SEQ ID NO: 1) (peptide-to-matrix ratio)=1:8300 under four conditions of (a) (3, 25, ×6, 337) (shot number ranges of 61-80), (b) (3, 25, ×4, 337) (shot number ranges of 41-60), (c) (4.2, 35, ×6, 337) (shot number ranges of 71-90) and (d) (3, 25, ×6, 355) (shot number ranges of 21-40). FIG. 12 shows the spectra with T_{early}≈968 K among the set of the MALDI spectra obtained for samples with angiotensin II (DRVYIHPF):CHCA (“DRVYIHPF” disclosed as SEQ ID NO: 4) (peptide-to-matrix ratio)=1:8300 under four conditions of (a) (3, 25, ×6, 337) (shot number ranges of 71-90), (b) (3, 25, ×4, 337) (shot number ranges of 31-50), (c) (4.2, 35, ×6, 337) (shot number ranges of 81-100) and (d) (3, 25, ×6, 355) (shot number ranges of 21-40).

Accordingly, it can be seen that the MALDI spectra of the peptides can be obtained reproducibly by selecting only the spectra having the same T_{early}. When the spectra having the same T_{early} were selected for the samples with different peptide-to-matrix ratios, the fragmentation patterns of the peptide ion and the matrix ion were the same and only the peptide-to-matrix ion signal ratio was different.

### Example 9

### Equilibrium of Proton Exchange Reaction

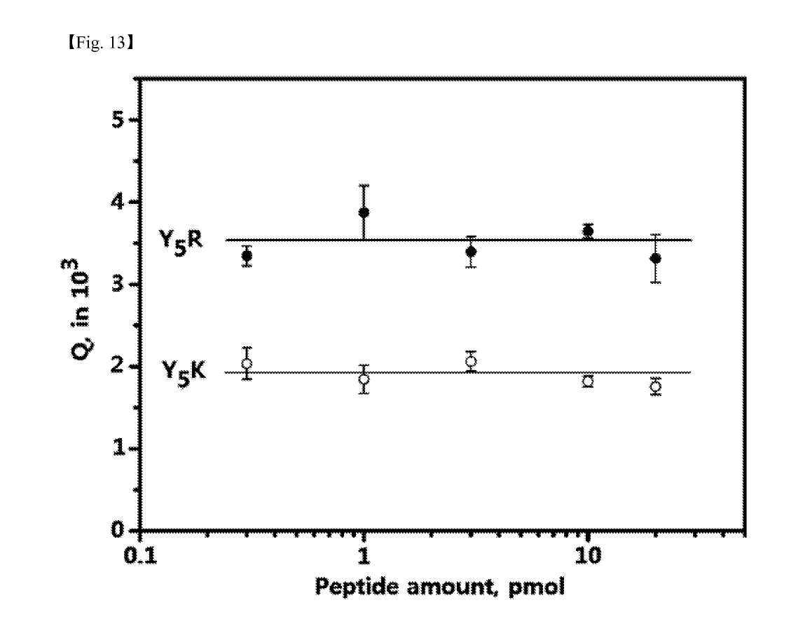

In MALDI mass spectrometry, a reaction occurs whereby a proton is transferred from a matrix to a peptide, i.e., M′H⁺+P→M′+PH⁺. The proton donor, M′H⁺, is [CHCA+H]⁺, [CHCA+H−H₂O]⁺ or [CHCA+H−CO₂]⁺ in this example. The fact that the temperature is determined by the peptide-to-matrix ion signal ratio means that the proton exchange reaction is nearly at thermal equilibrium. To confirm this, for samples of different concentrations, the reaction quotient Q=([M′]/[P])([PH⁺]/[M′H⁺]) was obtained at the same T_{early} and it was investigated whether it changes with concentration. After obtaining a set of MALDI spectra by repeatedly irradiating a laser to samples containing 0.3-20 pmol of Y₅R (SEQ ID NO: 3) or Y₅K (SEQ ID NO: 1) in 25 nmol of CHCA, T_{early} was calculated for each spectrum. Then, a set of spectra having the same T_{early} but different sample compositions was obtained by selecting only the spectra having a predetermined T_{early}. For the set of spectra, the intensities of the ions derived from the matrix and the peptide were measured. In order to calculate Q, it is necessary to know the identity of M′H⁺. However, if the purpose is to know whether Q is constant, the intensity of any ion that can serve as a proton donor may be used. It is because, if T_{early} is fixed, the relative intensities of all the ions derived from the matrix are determined. The fact that the fragmentation pattern of the matrix ion is independent of concentration means that the fragment ions such as [CHCA+H−H₂O]⁺ are not major proton donors. If one of the fragment ions is a major proton donor, the fragment ion will decrease faster than [CHCA+H]⁺ as the amount of the peptide is increased. Therefore, it is likely that the [CHCA+H]⁺ ion is the major proton donor. Assuming that part of the matrix ions which did not lose a proton will be dissociated, the sum of the intensities of all the ions derived from the matrix, i.e. Σ[matrix-derived ion], was seen as [M′H⁺]. Likewise, E[peptide-derived ion] was seen as [PH⁺]. The matrix-to-peptide ratio of the solid sample was used for calculation of the ratio of neutral molecules in gaseous state, i.e. ([M′]/[P]). The Q values obtained at T_{early}=950 K are shown in FIG. 13 as functions of the amount of the peptide (•: Y₅R (SEQ ID NO: 3), ∘: Y₅K (SEQ ID NO: 1)) contained in the solid sample. From FIG. 13, it is evident that the Q values are independent of the peptide amount, suggesting that the proton exchange reaction is nearly at thermal equilibrium. That is to say, the Q values shown in the figure are essentially the equilibrium constant K. It can be seen that the equilibrium constant K of the reaction whereby a proton is transferred from the matrix to the peptide is larger for Y₅R (SEQ ID NO: 3) than Y₅K (SEQ ID NO: 1). This is in good agreement with the fact that arginine (R) is a stronger base than lysine (K).

### Example 10

### Calibration Curve

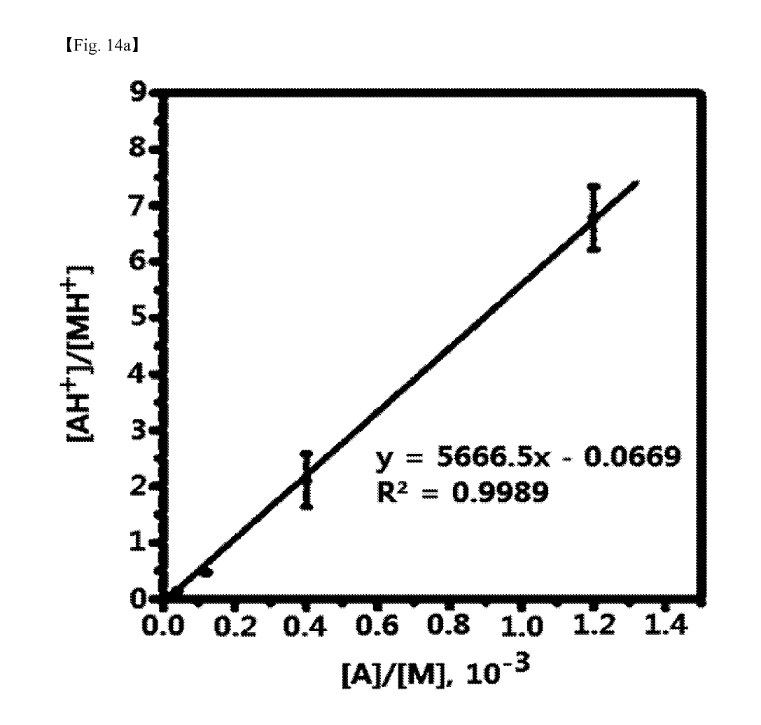

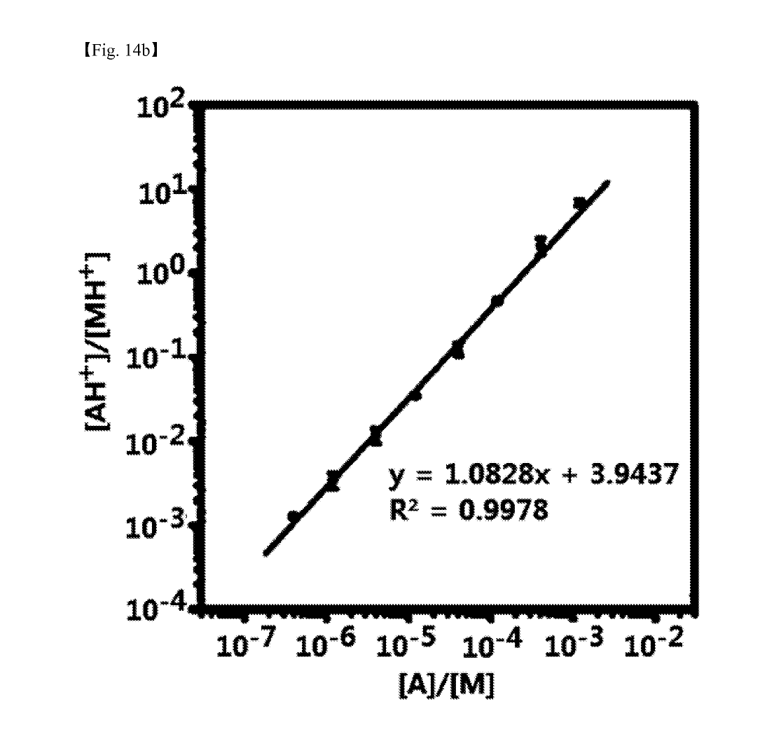

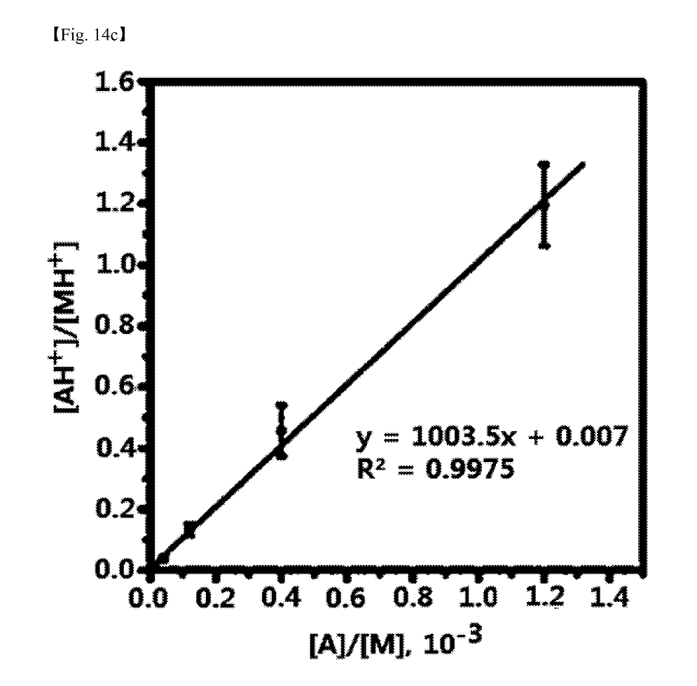

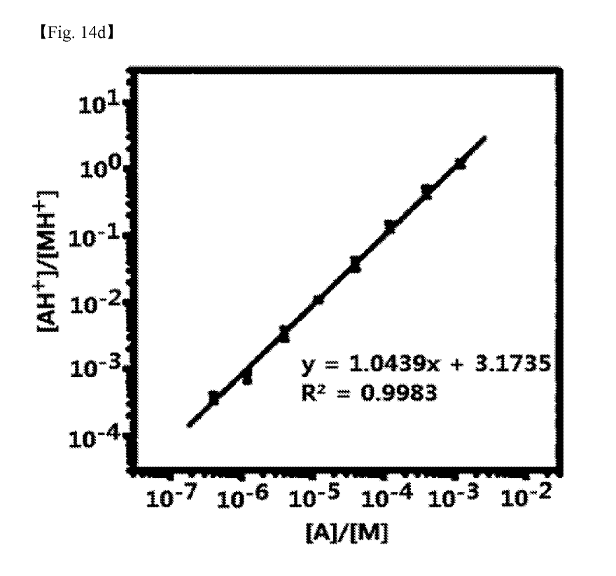

A laser pulse was irradiated to one spot of a sample containing 10 fmol to 30 pmol of Y₅R (SEQ ID NO: 3) or Y₅K (SEQ ID NO: 1) in 25 nmol of CHCA. MALDI mass spectra were obtained by irradiating the laser pulse to the spot until the ion signal disappeared. For each spectrum, T_{early} was determined by analyzing the fragmentation pattern of the peptide ion. Then, from each set of spectra, the spectrum having the same T_{early} in the range of 870-900 K were selected. Because the fragmentation pattern of the matrix ion changes with T_{early}, the fragmentation pattern was used as a measure of T_{early}. The spectra with the [CHCA+H−H₂O]+/[CHCA+H]⁺ intensity ratio=3-4.5 were selected. As can be seen from the calibration curve of FIGS. 14a-14d, there was a directly proportional relationship between [AH⁺]/[MH⁺] and [A]/[M] for Y5R (SEQ ID NO: 3) (FIGS. 14a and 14b) and Y5K (SEQ ID NO: 1) (FIGS. 14c and 14d).

### Example 11

### Quantitative Analysis Using Calibration Curve

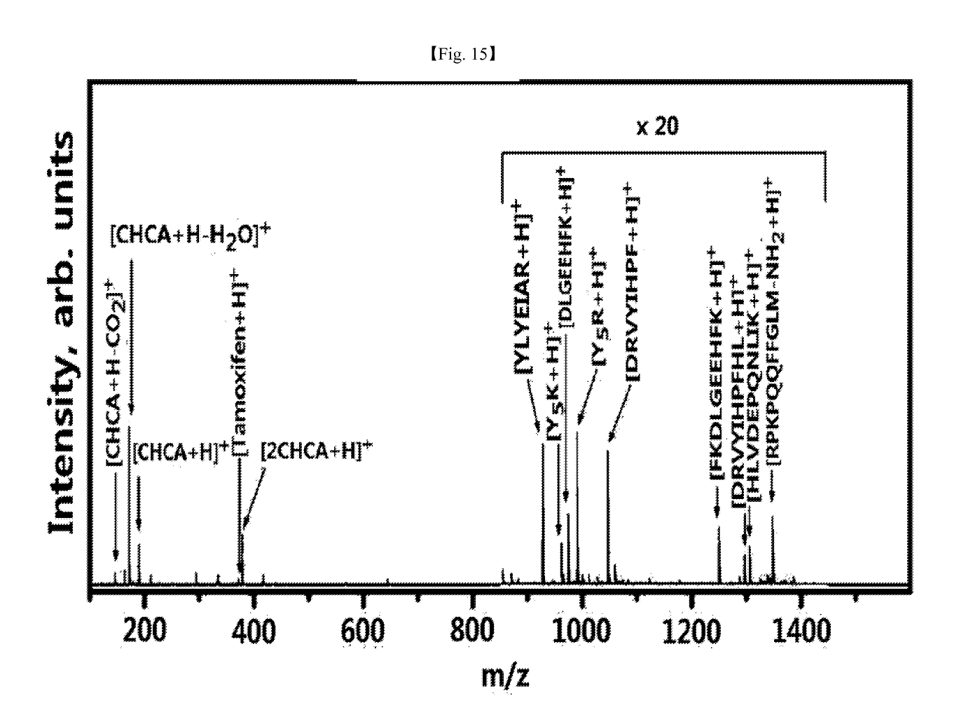

Samples containing nine peptides (0.3 pmol each) and 1.0 pmol of tamoxifen in 25 nmol of CHCA were prepared. The MALDI spectra of the samples are shown in FIG. 15. From FIG. 15, the temperature was selected such that [CHCA+H−H₂O]+/[CHCA+H]⁺ was 3-4.5, which corresponds to T_{early} of 870-900 K. A result of performing quantitative analysis of the peptides Y₅R (SEQ ID NO: 3) and Y₅K (SEQ ID NO: 1) included in the samples using the calibration curves of FIGS. 14a-14d is shown in Table 1.

TABLE 3

| | Y₅R | Y₅K |
|---|---|---|
| | (SEQ ID NO: 3) | (SEQ ID NO: 1) |
| Content (pmol) | 0.30 | 0.30 |
| Measurement result (pmol) | 0.25 | 0.26 |

As can be seen from FIGS. 14a-14d, [AH⁺]/[MH⁺] is almost directly proportional to [A]/[M]. Accordingly, the unknown amount of analyte can be determined with data obtained from only one concentration. A result of one-point calibration for the components in the samples is shown in Table 3.

TABLE 4

| | SEQ | | Measurement | |
|---|---|---|---|---|
| | ID | Content | result | Calibration |
| Analyte | NO: | (pmol) | (pmol) | curve |
| YLYEIAR | 5 | 0.30 | 0.31 | y = 2510.3x |
| Y₅K | 1 | 0.30 | 0.24 | y = 954.0x |
| DLGEEHFK | 8 | 0.30 | 0.32 | y = 1226.6x |
| Y₅R | 3 | 0.30 | 0.27 | y = 3162.6x |
| DRVYIHPF | 4 | 0.30 | 0.24 | y = 3098.1x |
| FKDLGEEHFK | 9 | 0.30 | 0.37 | y = 859.3x |
| DRVYIHPFHL | 10 | 0.30 | 0.33 | y = 544.1x |
| HLVDEPQNLIK | 11 | 0.30 | 0.40 | y = 521.5x |
| RPKPQQFFGLM-NH₂ | 12 | 0.30 | 0.31 | y = 1945.2x |
| Tamoxifen | | 1.0 | 0.74 | y = 886.0x |

As can be seen from Table 4, the method of the present disclosure can be applied to any analyte that is ionized by MALDI.

### Example 12

### Quantitative Analysis of Peptide by Dual Track TOF (Time-of-Flight) Mass Spectrometry

Instrument

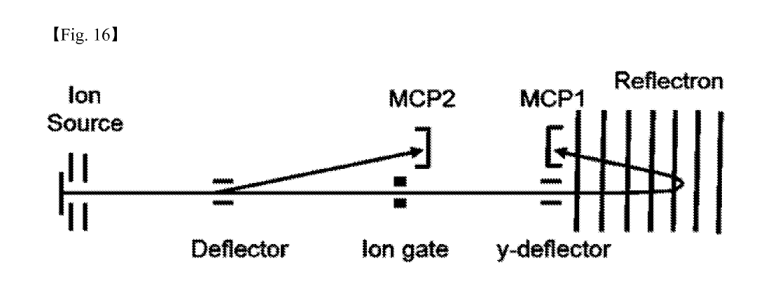

In this example, a MALDI-TOF mass spectrometer developed by the inventors of the present disclosure was used (Bae, Y. J.; Yoon, S. H.; Moon, J. H.; Kim, M. S. Bull. Korean Chem. Soc. 2010, 31, 92-99). The instrument used in this example is schematically described in FIG. 16. The original instrument consisted of a MALDI source with delayed extraction, a linear TOF analyzer, an ion gate, a reflectron and a multi-channel plate detector (MCP, #31849, Photonis USA, Sturbridge, Mass., USA). The distance between the source exit and the ion gate, the distance between the ion gate and the reflectron entrance and the distance between the reflectron exit and the detector (hereinafter, “MCP1”) were 880 mm, 350 mm and 20 mm, respectively.

In the improved instrument, a simple bipolar detector was installed on the ion optical axis located 430 mm away from the source exit. Let x be the ion optical axis and let xy be the plane on which the MCP1 is installed. Then, the deflection of ions by the deflector occurs along the y-axis direction away from the ion gate. A second MCP (hereinafter, “MCP2”) was installed on the xy-plane at a location 100 mm behind the ion gate and 50 mm (y-value) away from the ion optical axis (see FIG. 16). The location of MCP2 along the x-axis corresponds to the first time focal point of the instrument. The voltage of the deflector was controlled such that the deflected ion beam reached near the center of MCP2. When the average translational kinetic energy of the ions emerging from the source was 21.5 kV, the voltage was +1.2 kV and −1.2 kV. A 337-nm output from a nitrogen laser (MNL100, Lasertechnik Berlin, Berlin, Germany) focused by a lens (f=100 mm) was used for MALDI. In typical measurement, voltages of −2.08 kV and −1.32 kV were applied to MCP1 and MCP2, respectively.

Pulse

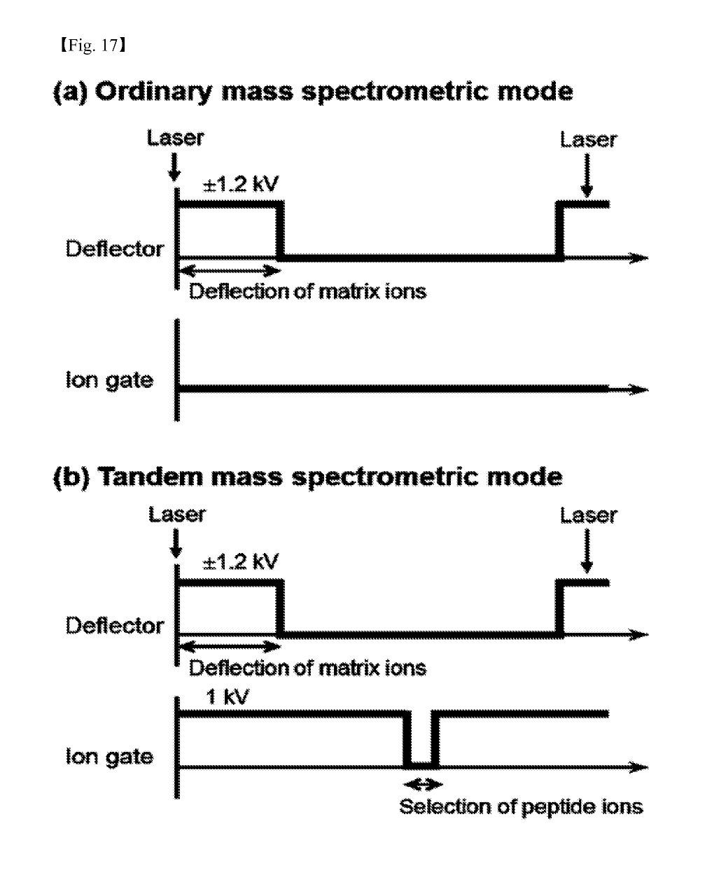

The instrument was operated in two modes, i.e., an ordinary mass spectrometric mode and a tandem mass spectrometric mode (FIG. 17). In the ordinary mode (FIG. 17 (a)), the ion gate was grounded during the operation of the instrument. The operation of the instrument was started with the operation of the deflector. Then, 5.7 μs after the irradiation of a MALDI laser, the operation of the deflector was stopped and the ion track was changed from a linear track to a deflected track. Then, the deflector was operated again 1 ms (or shorter) before the irradiation of the next laser pulse. Then, the instrument was ready for the next operation.

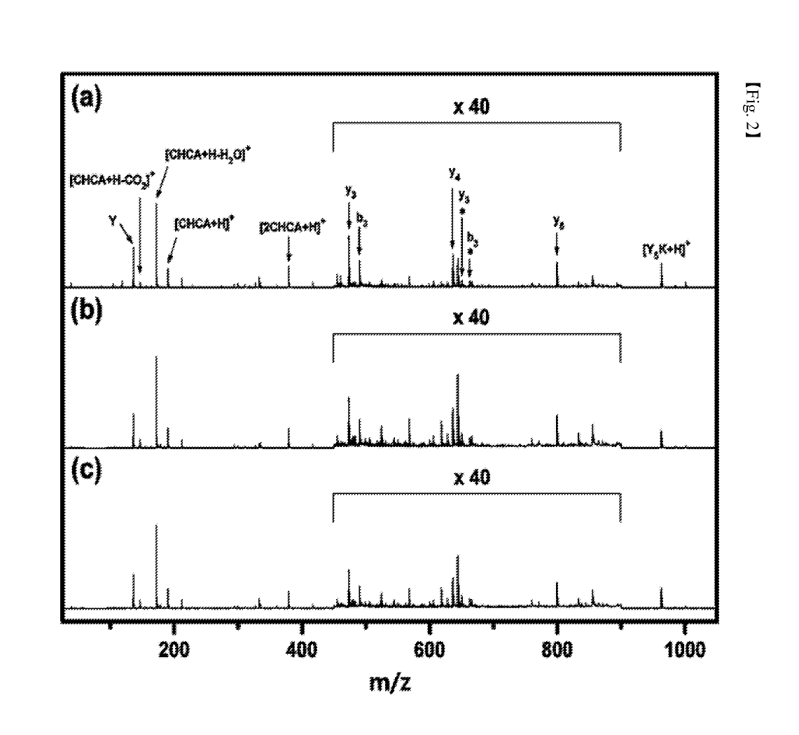

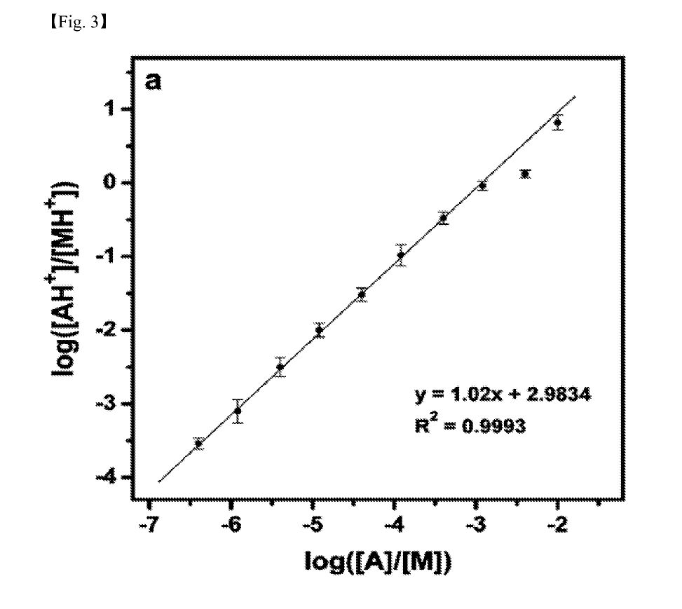

The tandem mass spectrometric mode (FIG. 2(b)) also started with the operation of the deflector. As in the ordinary mass spectrometric mode, the operation of the deflector was stopped 5.7 μs after the irradiation of a laser. When the peptide ion to be analyzed approached, the voltage of the ion gate that had been maintained from the start of the operation was turned off. Then, the voltage was turned on again to deflect the ions having a larger m/z value than that of the analyte ion. The ions occurring in the spectra obtained in the reflectron mode are the analyte ions and their PSD product ions.

There is another method of operating the instrument in the ordinary mode, wherein a reflectron track is used for the analysis of matrix-derived ions and a linear track is used for the analyte-derived ions. For example, the linear track may be used for the detection of ions having large m/z values, such as protein ions. In this case, the operation is started with the deflector turned off 14.7 μs after the irradiation of a laser, the deflector is turned on and the ion is moved to the linear track.

Sample

Y₅K (SEQ ID NO: 1) and angiotensin II (DRVYIHPF (SEQ ID NO: 4)) were purchased from Peptron (Daejeon, Korea). A protein mixture (Protein Standard II containing trypsinogen, protein A and bovine serum albumin (BSA)) was purchased from Bruker Daltonik GmbH (Bremen, Germany). Cytochrome c and CHCA were purchased from Sigma (St. Louis, Mo., USA). An aqueous solution of the peptide was mixed with a solution of CHCA in water/acetonitrile (1:1). 1.0 μL of the solution containing 0.03-30 pmol of the peptide in 25 nmol of CHCA was loaded and vacuum-dried.

Acquisition of Temperature-Controlled MALDI Spectra

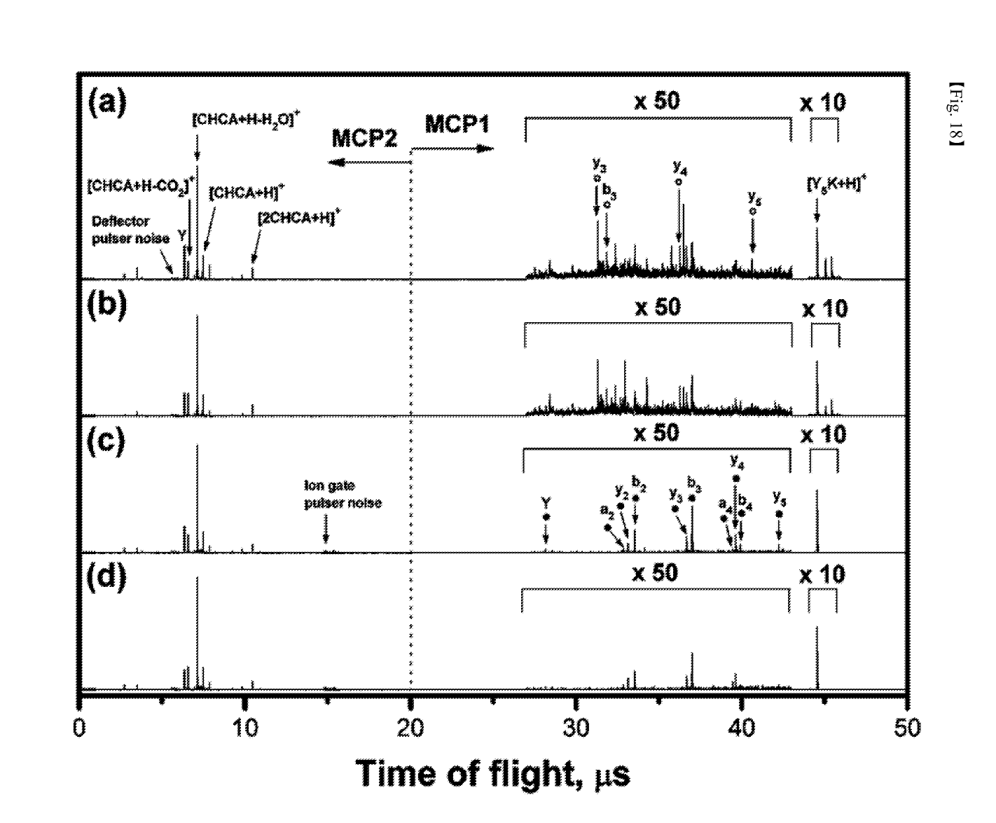

In this example, the ratio of some ions derived from the matrix, e.g., [M+H−H₂O]⁺-to-[M+H]⁺ ratio, was used as a measure of T_{early}. That is to say, the [CHCA+H−CO₂]⁺-to-[CHCA+H−H₂O]⁺ ratio was used as a measure of T_{early} and the transmittance through an optical density filter was controlled for feedback control of T_{early}. Data acquisition was stopped when the laser pulse energy became 3.5 times the threshold energy. The temperature-controlled CHCA MALDI spectra of Y₅K (SEQ ID NO: 1) in the shot number ranges of 31-40 and 101-110 are shown in FIG. 18. Each spectrum was obtained by summing the spectra obtained by the two detectors. Important matrix-derived and analyte-derived ions were specially marked. It is to be noted that the two spectra are essentially identical. The spectra of the same shot number ranges obtained in the tandem mode are also shown in FIG. 18. Likewise, the two spectra obtained in different shot number ranges are essentially identical. In this operation mode, most of the ion signals detected by MCP1 due to the activation of the ion gate were removed. The ions occurring in the obtained tandem mass spectra were mostly [Y₅K+H]⁺ (“Y₅K” disclosed as SEQ ID NO: 1) and its PSD products, e.g., aₙ (n=2-5), bₙ (n=2.5) and yₙ (n=1-5). The tandem mass spectrometric mode in dual track TOF mass spectrometry is very useful for the identification of peptides.

Calibration Curve

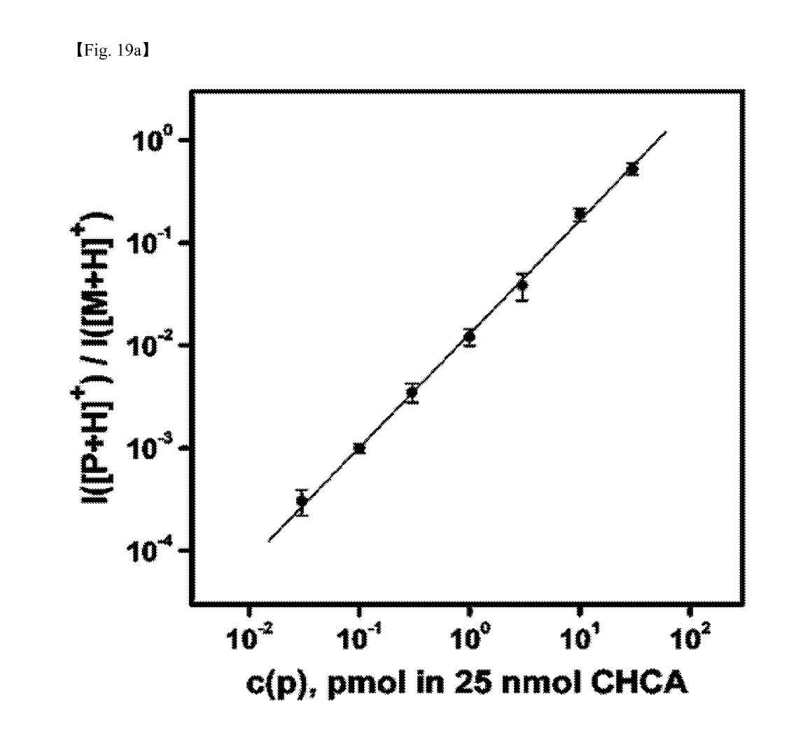

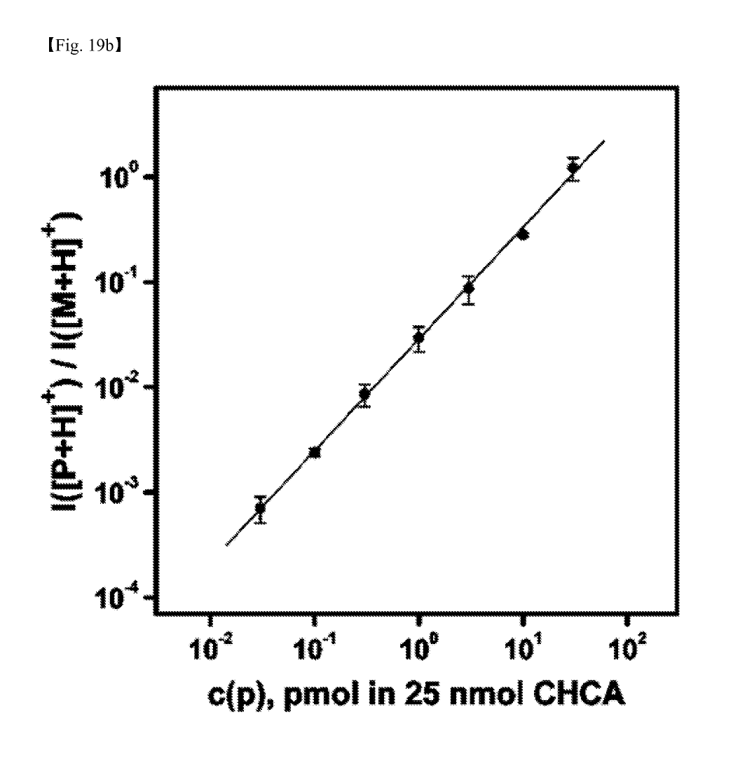

In this example, the dual track TOF instrument equipped with MCP1 and MCP2, which detect analyte-derived ions and matrix-derived ions, respectively, was operated in the tandem mass spectrometric mode. The I([P+H]⁺)/I([M+H]) vs. c(P) data obtained from samples containing 0.03-30 pmol of Y₅K (SEQ ID NO: 1) in 25 nmol of CHCA showed excellent linearity (FIG. 19). A similar result for angiotensin II is also shown in FIG. 19.

Use of Linear TOF Mode for Protein Ions and Reflectron Mode for Matrix-Derived Ions

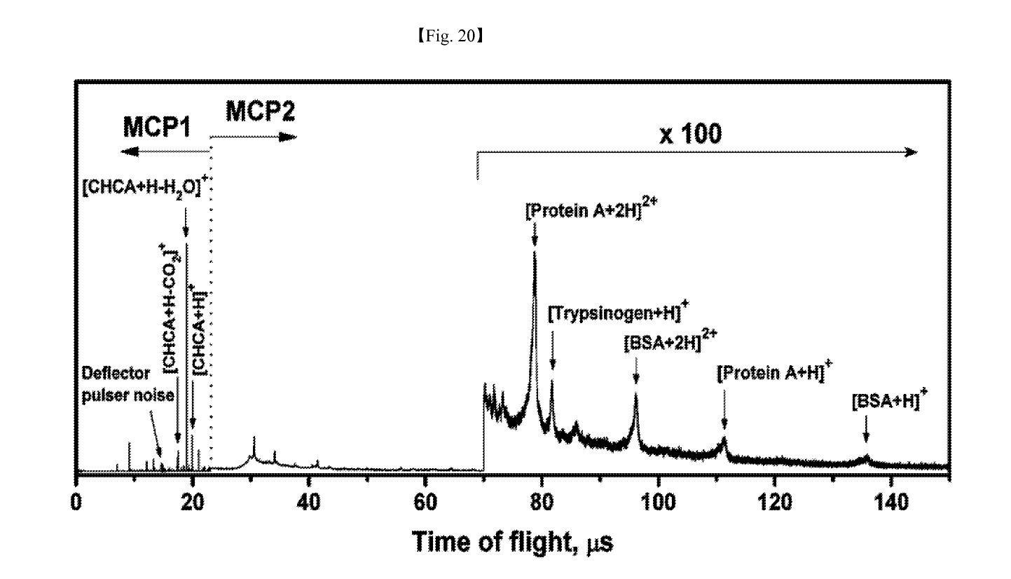

It is well known that the ion signals of high-molecular-weight proteins detected in the reflectron mode are much weaker than those detected in the linear TOF mode. The reflectron mode is not useful for the resolution of protein isotope peaks unless high-resolution TOF analyzer is used. For this reason, an MCP installed on the final electrode of the reflectron is often used to detect the protein ion signals in the linear mode. In this case, use of a high-gain MCP is essential and removal of matrix-derived ions by the reflectron is required. An alternative to this is to use dual track TOF and analyze the protein ions and the matrix-derived ions in the linear (MCP2) and reflectron (MCP1) modes, respectively. The CHCA-MALDI spectrum of a sample containing trypsinogen, protein A and BSA is shown in FIG. 20. From the spectrum, T_{early} was estimated from the [CHCA+H−CO₂]⁺-to-[CHCA+H−H₂O]⁺ ratio as about 920 K.

1. A method for measuring mass spectra of ions generated at constant temperature, the method comprising selecting only the mass spectra having the same total ion count from among multiple mass spectra obtained from ions generated by applying energy to a sample having an analyte mixed therein.

2. The method according to claim 1, wherein a means of applying energy to the sample is a laser.

3. The method according to claim 2, wherein the laser is a nitrogen laser or a Nd:YAG laser.

4. The method according to claim 3, wherein the laser is irradiated to one spot of the sample multiple times.

5. The method according to claim 3, wherein the laser is irradiated to multiple spots of the sample.

6. A method for measuring the equilibrium constant of a proton exchange reaction between a matrix and an analyte at constant temperature, the method comprising:
(i) selecting only the mass spectra having the same total ion count from among multiple mass spectra obtained from ions generated by applying energy to a sample having an analyte mixed therein; and
(ii) measuring the value obtained by dividing the signal intensity of the analyte ion by the signal intensity of the matrix ion (ion signal ratio) from the MALDI mass spectra obtained in the step (i),
wherein the ion signal ratio is divided by the concentration of the analyte divided by the concentration of the matrix (concentration ratio) to measure the equilibrium constant.

7. The method according to claim 6, wherein a means of applying energy to the sample is a laser.

8. The method according to claim 7, wherein the laser is a nitrogen laser or a Nd:YAG laser.

9. The method according to claim 7, wherein the laser is irradiated to one spot of the sample multiple times.

10. The method according to claim 7, wherein the laser is irradiated to multiple spots of the sample.

11. A method for obtaining a calibration curve for MALDI mass spectrometry, the method comprising:
(i) selecting only the mass spectra having the same total ion count from among multiple mass spectra obtained from ions generated by applying energy to a sample having an analyte mixed therein;
(ii) measuring the value obtained by dividing the signal intensity of the analyte ion by the signal intensity of the matrix ion (ion signal ratio) from the MALDI mass spectra obtained in the step (i); and
(iii) obtaining a calibration curve for MALDI mass spectrometry by plotting the ion signal ratio against the concentration of the analyte divided by the concentration of the matrix (concentration ratio).

12. The method according to claim 11, wherein a means of applying energy to the sample is a laser.

13. The method according to claim 12, wherein the laser is a nitrogen laser or a Nd:YAG laser.

14. The method according to claim 12, wherein the laser is irradiated to multiple spots of the sample.

15. The method according to claim 12, wherein the laser is irradiated to multiple spots of the sample.

16. A method for quantitative analysis of an analyte using MALDI mass spectrometry, the method comprising:
(i) selecting only the mass spectra having the same total ion count from among multiple mass spectra obtained from ions generated by applying energy to a sample having an analyte mixed therein;
(ii) measuring the value obtained by dividing the signal intensity of the analyte ion by the signal intensity of the matrix ion (ion signal ratio) from the MALDI mass spectra obtained in the step (i); and
(iii) calculating the molar concentration of the analyte by substituting the molar concentration of the matrix and the ion signal ratio obtained in the step (ii) into a calibration curve for MALDI mass spectrometry of Equation (7).
[A]=(I_{AH}⁺/I_{MH}⁺)[M]/K (7)

17. The method according to claim 16, wherein a means of applying energy to the sample is a laser.

18. The method according to claim 17, wherein the laser is a nitrogen laser or a Nd:YAG laser.

19. The method according to claim 16, wherein the laser is irradiated to one spot of the sample multiple times.

20. The method according to claim 16, wherein the laser is irradiated to multiple spots of the sample.

21. A matrix for quantitative analysis of an analyte using MALDI mass spectrometry.

22. The matrix according to claim 21, wherein the matrix is selected from a group consisting of CHCA (α-cyano-4-hydroxycinnamic acid), DHB (2,5-dihydroxybenzoic acid), sinapinic acid, 4-hydroxy-3-methoxycinnamic acid, picolinic acid, 3-hydroxypicolinic acid, 2,6-dihydroxyacetophenone, 1,5-diaminonapthalene, 2,4,6-trihydroxyacetophenone, 2-(4′-hydroxybenzeneazo)benzoic acid, 2-mercaptobenzothiazole, chlorocyanocinnamic acid and fluorocyanocinnamic acid.

23. A method for quantitative analysis comprising a step obtaining multiple MALDI mass spectra from ions generated by applying energy to a sample having an analyte mixed therein.

24. The method according to claim 23, wherein a matrix selected from a group consisting of CHCA (α-cyano-4-hydroxycinnamic acid), DHB (2,5-dihydroxybenzoic acid), sinapinic acid, 4-hydroxy-3-methoxycinnamic acid, picolinic acid, 3-hydroxypicolinic acid, 2,6-dihydroxyacetophenone, 1,5-diaminonapthalene, 2,4,6-trihydroxyacetophenone, 2-(4′-hydroxybenzeneazo)benzoic acid, 2-mercaptobenzothiazole, chlorocyanocinnamic acid and fluorocyanocinnamic acid is used.

25. The method according to claim 23, wherein a means of applying energy to the sample is a laser.

26. The method according to claim 25, wherein the laser is a nitrogen laser or a Nd:YAG laser.

27. The method according to claim 25, wherein the laser is irradiated to one spot of the sample multiple times.

28. The method according to claim 25, wherein the laser is irradiated to multiple spots of the sample.

29. A use of a matrix for use in a method for quantitative analysis, the method comprising: (i) selecting only the mass spectra having the same fragmentation pattern of a matrix ion or an analyte ion from among multiple mass spectra obtained from ions generated by applying energy to a sample having a predetermined amount of a matrix and an unknown amount of an analyte mixed therein; (ii) measuring the value obtained by dividing the signal intensity of the analyte ion by the signal intensity of the matrix ion (ion signal ratio) from the MALDI mass spectra selected in the step (i); and (iii) calculating the molar concentration of the analyte by substituting the molar concentration of the matrix and the ion signal ratio obtained in the step (ii) into a calibration curve for MALDI mass spectrometry of Equation (7).
[A]=(I_{AH}⁺/I_{MH}⁺)[M]/K (7)

30. The use according to claim 29, wherein the matrix is selected from a group consisting of CHCA (α-cyano-4-hydroxycinnamic acid), DHB (2,5-dihydroxybenzoic acid), sinapinic acid, 4-hydroxy-3-methoxycinnamic acid, picolinic acid, 3-hydroxypicolinic acid, 2,6-dihydroxyacetophenone, 1,5-diaminonapthalene, 2,4,6-trihydroxyacetophenone, 2-(4′-hydroxybenzeneazo)benzoic acid, 2-mercaptobenzothiazole, chlorocyanocinnamic acid and fluorocyanocinnamic acid.

31. The use according to claim 29, wherein a means of applying energy to the sample is a laser.

32. The use according to claim 31, wherein the laser is a nitrogen laser or a Nd:YAG laser.

33. The use according to claim 31, wherein the laser is irradiated to one spot of the sample multiple times.

34. The use according to claim 31, wherein the laser is irradiated to multiple spots of the sample.

35. A use of a matrix for use in a method for quantitative analysis, the method comprising: (i) selecting only the mass spectra having the same fragmentation pattern of a matrix ion from among multiple mass spectra obtained from ions generated by applying energy to a sample having a predetermined amount of a matrix and a third material and an unknown amount of an analyte mixed therein; (ii) measuring the value obtained by dividing the signal intensity of the analyte ion by the signal intensity of the matrix ion (ion signal ratio) from the MALDI mass spectra selected in the step (i); and (iii) calculating the molar concentration of the analyte by substituting the molar concentration of the matrix and the ion signal ratio obtained in the step (ii) into a calibration curve for MALDI mass spectrometry of Equation (7).
[A]=(I_{AH}⁺/I_{MH}⁺)[M]/K (7)

36. The use according to claim 35, wherein a means of applying energy to the sample is a laser.

37. The use according to claim 36, wherein the laser is a nitrogen laser or a Nd:YAG laser.

38. The use according to claim 36, wherein the laser is irradiated to one spot of the sample multiple times.

39. The use according to claim 36, wherein the laser is irradiated to multiple spots of the sample.


SEQUENCE LISTING (12 sequences)

SEQ ID NO: 1 - protein, 6 aa, Artificial Sequence
  Description of Artificial Sequence Synthetic peptide
YYYYYK

SEQ ID NO: 2 - protein, 6 aa, Artificial Sequence
  Description of Artificial Sequence Synthetic peptide
YYYYYY

SEQ ID NO: 3 - protein, 6 aa, Artificial Sequence
  Description of Artificial Sequence Synthetic peptide
YYYYYR

SEQ ID NO: 4 - protein, 8 aa, Artificial Sequence
  Description of Artificial Sequence Synthetic peptide
DRVYIHPF

SEQ ID NO: 5 - protein, 7 aa, Artificial Sequence
  Description of Artificial Sequence Synthetic peptide
YLYEIAR

SEQ ID NO: 6 - protein, 5 aa, Artificial Sequence
  Description of Artificial Sequence Synthetic peptide
YGGFL

SEQ ID NO: 7 - protein, 6 aa, Artificial Sequence
  Description of Artificial Sequence Synthetic peptide
YYYYYX

SEQ ID NO: 8 - protein, 8 aa, Artificial Sequence
  Description of Artificial Sequence Synthetic peptide
DLGEEHFK

SEQ ID NO: 9 - protein, 10 aa, Artificial Sequence
  Description of Artificial Sequence Synthetic peptide
FKDLGEEHFK

SEQ ID NO: 10 - protein, 10 aa, Artificial Sequence
  Description of Artificial Sequence Synthetic peptide
DRVYIHPFHL

SEQ ID NO: 11 - protein, 11 aa, Artificial Sequence
  Description of Artificial Sequence Synthetic peptide
HLVDEPQNLIK

SEQ ID NO: 12 - protein, 11 aa, Artificial Sequence
  Description of Artificial Sequence Synthetic peptide
RPKPQQFFGLM